(19) United States
(12) Patent Application Publication
(10) Pub. No.: US 2013/0041623 A1
(43) Pub. Date: Feb. 14, 2013

(54) THEFT DETECTION NODES AND SERVERS, METHODS OF ESTIMATING AN ANGLE OF A TURN, METHODS OF ESTIMATING A DISTANCE TRAVELED BETWEEN SUCCESSIVE STOPS, AND METHODS AND SERVERS FOR DETERMINING A PATH TRAVELED BY A NODE

(71) Applicants: The University of Memphis Research Foundation, Memphis, TN (US); The Regents of the University of Michigan, Ann Arbor, MI (US)

(72) Inventors: Santosh Kumar, Germantown, TN (US); Prabal Dutta, Oakland, CA (US); Santanu Guha, Memphis, TN (US); Kurt Plarre, Germantown, TN (US); Daniel Lissner, Memphis, TN (US); Somnath Mitra, Memphis, TN (US); Bhagavathy Krishna, Memphis, TN (US)

(73) Assignees: THE REGENTS OF THE UNIVERSITY OF MICHIGAN, Ann Arbor, MI (US); THE UNIVERSITY OF MEMPHIS RESEARCH FOUNDATION, Memphis, TN (US)

(21) Appl. No.: 13/657,472

(22) Filed: Oct. 22, 2012

Related U.S. Application Data
(63) Continuation of application No. 13/412,532, filed on Mar. 5, 2012, now abandoned.
Application No. 13/412,532 is a continuation of application No. 13/187,272, filed on Jul. 20, 2011, now abandoned.
(60) Provisional application No. 61/365,960, filed on Jul. 20, 2010.
(60) Provisional application No. 61/409,685, filed on Nov. 3, 2010.

(51) Int. Cl. G06F 15/00

(52) U.S. Cl. 702/158

(57) ABSTRACT

One aspect of the invention provides a theft detection node including: a power source; an accelerometer; a gyroscope; a transmitter; and a microcontroller in communication with the power source, the motion detector, and the transmitter. The microcontroller is programmed to determine whether the theft detection node is being transported and, if the theft detection node is being transported: estimate the distance traveled between successive stops and transmit the estimated distance to a server. Another aspect of the invention provides a method of determining a path traveled by a node. The method includes: generating a Hidden Markov Model having a plurality of hidden states, each hidden state corresponding to a road segment; receiving information from the node about one or more turns and the distance traveled between successive stops; and determining the most likely path for the distance between successive stops and a distance between successive turns.

### CROSS-REFERENCE TO RELATED APPLICATIONS

This application is a continuation application of U.S. application Ser. No. 13/412,532 filed on Mar. 5, 2012; which is a continuation application of U.S. application Ser. No. 13/187,272 filed on Jul. 20, 2011; which claims the benefit of U.S. Provisional Patent Application Ser. No. 61/365,960, filed Jul. 20, 2010, and U.S. Provisional Patent Application Ser. No. 61/409,685, filed Nov. 3, 2010. The entire content of each of these applications is hereby incorporated by reference herein.

### BACKGROUND

Burglary is a traumatic event that continues to pervade society. Burglar alarms, closed circuit surveillance, and the like deter criminals but rarely lead to the arrest of suspects. Investigating burglary post facto is expensive, difficult, and a relatively lower priority to police.

According to the FBI Uniform Crime Reporting Program, burglary offenses accounted for 22.1% of all estimated property crimes and resulted in $4.3 billion in losses in 2007. Loss of property aside, a burglary incident is a traumatic experience for its victims.

Due to the difficulty and expense of investigation, burglaries often do not receive the same priority from resource-strapped law enforcement agencies as other crimes such as homicide. Consequently, burglary continues to pervade even the most prosperous nations and may become more prevalent in the current economic recession, despite a plethora of anti-burglary devices that have been commercially available for more than a decade.

Most existing anti-burglary systems such as security cameras, alarm systems, motion sensor based alarm systems, and the like only deter burglars, leaving burglars to seek more vulnerable properties in the neighborhood. In the event of a bold burglar stealing an alarmed item, alarms are useful only if they help to catch the burglar at the scene of crime. Once the burglar flees the scene of crime, recovering the stolen item is extremely difficult. Resource-strapped law enforcement agencies are understandably reluctant to undertake these expensive investigations when more serious crimes are competing for their attention.

Law enforcement agencies would very much like to address burglaries because one burglary in a neighborhood makes citizens in the entire neighborhood feel vulnerable. However, currently available asset tracking devices suffer from several deficiencies.

For example, many tracking devices (e.g., systems available under the LOJACK® trademark from LoJack Corporation of Westwood, Mass.) utilize the Global Positioning System (GPS) and/or cellular infrastructure to obtain location information and cellular infrastructure to transmit location information. The lifespan of such devices without charging ranges between about three days to one week.

Other systems employ the frequent exchange of messages among neighboring sensors hidden in parked cars to detect in any neighboring vehicles are missing from a parking lot. However, such an approach quick drains the battery of the sensor.

Accordingly, there is a need for an affordable, easy-to-use, low-power theft detection system.

### SUMMARY OF THE INVENTION

One aspect of the invention provides a theft detection node including: a power source; an accelerometer; a gyroscope; a transmitter; and a microcontroller in communication with the power source, the motion detector, and the transmitter. The microcontroller is programmed to determine whether the theft detection node is being transported and, if the theft detection node is being transported: estimate the distance traveled between successive stops and transmit the estimated distance to a server.

This aspect of the invention can have a variety of embodiments. The microcontroller can be further programmed to process signals generated by the accelerometer to remove jitters and noise. The microcontroller can be further programmed to perform a 2^{nd} order Runge Kutta integration on the signals. The microcontroller can be further programmed to apply a 2^{nd} order Butterworth filter to the signals.

The microcontroller can be further programmed to compute the median of m samples in a plurality of windows of the signals and compute the mean of n of a plurality of windows of the medians, wherein m and n are positive integers. The value m can be selected from the group consisting of: about 5, about 10, about 15, about 20, about 25, about 30, about 35, about 40, about 45, about 50, about 55, about 60, about 65, about 70, about 75, about 80, about 85, about 90, about 95, and about 100. The value n is selected from the group consisting of: about 5, about 10, about 15, about 20, about 25, about 30, about 35, about 40, about 45, about 50, about 55, about 60, about 65, about 70, about 75, about 80, about 85, about 90, about 95, and about 100.

The microcontroller can be further programmed to remove any radial components of acceleration from the means. The microcontroller can be further programmed to subtract a mean of the means between the successive stops from the means. The microcontroller can be further programmed to compute a double integral of the means.

The microcontroller can be further programmed to: maintain a running mean velocity over a period of time, sum acceleration values between the successive stops, and calculate an elapsed time between the successive stops.

The distance traveled between the successive stops can be estimated using d=( v̅−b*t)*t, where v̅ is the running mean velocity, b is the sum of all acceleration values between the successive stops, and t is the time elapsed between the successive stops. The period of time can be about 1 second.

The microcontroller can be further programmed to, if the theft detection node is stationary, reorient the axes of the accelerometer. The microcontroller can be further programmed to: estimate the direction of a turn and transmit the estimated direction of the turn to the server.

The transmitter can be a cellular telephone transmitter. The transmitter can be compatible with one or more standards selected from the group consisting of: Global System for Mobile Communications (GSM), General Packet Radio Service (GPRS), Code Division Multiple Access (CDMA), Evolution-Data Optimized (EV-DO), Enhanced Data Rates for GSM Evolutions (EDGE), Digital Enhanced Cordless Telecommunications (DECT), and Integrated Digital Enhanced Network (iDEN). The transmitter can be a transceiver.

The power source can be a battery. The battery can be a button cell. The battery can be a lithium battery.

The theft detection node can further include a motion detector. The motion detector can be a vibration dosimeter. The motion detector can be a piezoelectric vibratab. The microcontroller can be configured to receive a wake-up signal from the motion detector. The microcontroller can be configured to determine whether the theft detection node is being transported in a motor vehicle. The microcontroller can determine whether the node is being transported by a motor vehicle through use of a classification algorithm.

Another aspect of the invention provides a theft detection server including: a communication module for communicating with at least one theft detection node; a storage module for storing representations of one or more maps; and a processing module for determining a path traveled by the theft detection node.

This aspect of the invention can have a variety of embodiments. The processing module can determine the path through use of Viterbi decoding over a Hidden Markov Model having a plurality of states. The Hidden Markov Model can have a starting state including all intersections within a radius r from a location where the theft detection node was initially deployed. Value r can be distance selected from the group consisting of about 100 meters, about 500 meters, about 1 kilometer, about 2 kilometers, about 3 kilometers, about 4 kilometers, about 5 kilometers, and about 10 kilometers. Each of the intersections can be assigned a uniform probability. A transition in the Hidden Markov Model can be created when the theft detection node detects a turn.

The communication module can be programmed to communicate with the theft detection node via a cellular telephone infrastructure.

Another aspect of the invention provides a method of estimating an angle of a turn utilizing a gyroscope. The method includes receiving signals indicative of orientation from the gyroscope and performing a single integration of the signals.

This aspect of the invention can have a variety of embodiments. The method can further include: receiving signals indicative of a stop from an accelerometer and estimating drift of the gyroscope during the stop. The method can further include: detecting a change in orientation of the gyroscope and reorienting the axes of the accelerometer.

Another aspect of the invention provides a method of estimating a distance traveled between two successive stops utilizing an accelerometer. The method includes: receiving signals indicative of acceleration from the accelerometer; processing the signals to remove noise and jitters; computing the median of m samples in a plurality of windows of the signals, wherein m is a positive integer; computing the mean of n of a plurality of windows of the medians, wherein n is a positive integer; removing any radial components of acceleration from the means; subtracting a mean of the means between the two successive stops from the means; and computing a double integral of the means.

This aspect of the invention can have a variety of embodiments. The method can further include: detecting that the accelerometer is stationary; utilizing signals from the accelerometer to determine the orientation of the accelerometer relative to gravity; and resolving future accelerometer signals to a fixed reference frame. The step of processing the signals to remove noise and jitters can include performing a 2^{nd} order Runge Kutta integration. The step of processing the signals to remove noise and jitters can include passing the signals through a 2^{nd} order Butterworth filter.

The value m can be selected from the group consisting of: about 5, about 10, about 15, about 20, about 25, about 30, about 35, about 40, about 45, about 50, about 55, about 60, about 65, about 70, about 75, about 80, about 85, about 90, about 95, and about 100. The value n can be selected from the group consisting of: about 5, about 10, about 15, about 20, about 25, about 30, about 35, about 40, about 45, about 50, about 55, about 60, about 65, about 70, about 75, about 80, about 85, about 90, about 95, and about 100.

Another aspect of the invention provides a method of estimating a distance traveled between two successive stops utilizing an accelerometer. The method includes: receiving signals indicative of acceleration from the accelerometer; processing the signals to remove noise and jitters; maintaining a running mean velocity over a period of time; summing acceleration values between the successive stops; and calculating an elapsed time between the successive stops, thereby estimating a distance traveled between two successive stops.

This aspect of the invention can have a variety of embodiments. The distance traveled between the successive stops can be estimated using d=( v̅−b*t)*t, where v̅ is the running mean velocity, b is the sum of all acceleration values between the successive stops, and t is the time elapsed between the successive stops. The period of time can be about 1 second.

Another aspect of the invention provides a method of determining a path traveled by a node. The method includes: generating a Hidden Markov Model having a plurality of hidden states, each hidden state corresponding to a road segment; receiving information about a turn t from a road segment j to a road segment k from the node; if the turn t is the first turn, setting a start state; if the turn t is not the first turn, computing the angle γ of the turn t; receiving a distance d traveled by the node between the turn t and an immediately previous turn t−1 from road segment i to the road segment j; associating margins of error ε_{d} and ε_{γ} with distance d and angle γ, respectively; pruning one or more hidden states based on the distance d and angle γ to produce a candidate set C; assigning a prior probability

$${P}_{i} ( j ) = \frac{1}{\vert C \vert}$$

to each hidden state in the candidate set C; estimating evidence for Bayesian inferencing Pᵢ(d|j); computing a marginal probability P(d)=ΣP(j)P(d|j); and computing a transition probability

$$P ( j \vert d ) = \frac{P ( d \vert j ) P ( j )}{P ( d )} .$$

This aspect of the invention can have a variety of embodiments. The start state can include all intersections within a radius r from a location where the node was initially deployed. The value r can be a distance selected from the group consisting of about 100 meters, about 500 meters, about 1 kilometer, about 2 kilometers, about 3 kilometers, about 4 kilometers, about 5 kilometers, and about 10 kilometers.

The evidence for Bayesian inference Pᵢ(d|j) can be calculated according to the expression

$$P ( d \vert j ) = \frac{1}{σ \sqrt{2 π}} {e}^{- {( d - {d}_{j} )}^{2} / 2 {σ}^{2}} ,$$

wherein dⱼ is the actual length of road segment jεC from start of road segment i.

The method can further include computing an emission probability

$${P}_{E} = P ( {y}_{1 , m} \vert {x}_{1 , m} ) {\prod }_{i = 1}^{m - 1} P ( {y}_{i , i + 1} \vert {x}_{i , i + 1} ) .$$

Another aspect of the invention provides a server configured to determine a path traveled by a node. The server is configured to: generate a Hidden Markov Model having a plurality of hidden states, each hidden state corresponding to a road segment; receive information about one or more turns and the distance traveled between successive stops; and determine the most likely path for the distance between successive stops and a distance between successive turns.

Another aspect of the invention provides a method of determining a path traveled by a node. The method includes: generating a Hidden Markov Model having a plurality of hidden states, each hidden state corresponding to a road segment; receiving information from the node about one or more turns and the distance traveled between successive stops; and determining the most likely path for the distance between successive stops and a distance between successive turns.

### FIGURES

For a fuller understanding of the nature and desired objects of the present invention, reference is made to the following detailed description taken in conjunction with the figure wherein:

FIG. 1 depicts a theft detection system in accordance with one embodiment of the invention.

FIGS. 2A and 2B depict tag nodes in accordance with various embodiments of the invention.

FIG. 3A depicts a vibration dosimeter according to one embodiment of the invention. FIG. 3B depicts the operation vibration dosimeter according to one embodiment of the invention.

FIG. 4A is a state transition diagram depicting the operation of a tag node according to one embodiment of the invention. FIG. 4B depicts an algorithm for detecting if a tag node is being moved in a vehicle.

FIG. 5A depicts the acceleration signal generated by a tag node according to one embodiment of the invention. FIG. 5B depicts the interquartile range of a signal obtained from acceleration measurements from a tag node according to one embodiment of the invention. FIG. 5C depicts the variance of a signal obtained from acceleration measurements from a tag node according to one embodiment of the invention. FIG. 5D is a scatter plot of feature values for vehicular and non-vehicular movement. The clusters for the non-vehicular movement closer to the x-axis correspond to static scenarios and the clusters farther from the x-axis correspond to manual movement (e.g., trolley, walking, etc.).

FIG. 6A depicts a lane change followed by a right turn as superimposed on a map. FIG. 6B depicts the yaw signal variation with a lane change followed by a right turn. FIG. 6C depicts the detection of a lane change and a turn using the first difference signal. FIG. 6D depicts the estimation of angles of a turn and a lane change.

FIG. 7 is a scatter plot depicting distinguishable differences in thresholds of gyro yaw first difference for left turns, right turns, left lane shifts, and right lane shifts.

FIG. 8A depicts a method of estimating the distance traveled between successive turns and/or stops based on signals from inertial sensors. (Broken lines indicate inputs.)

FIG. 8B depicts an alternate method 800b for obtaining distance estimates between successive stops.

FIG. 9 depicts approaches for accounting for radial acceleration in various scenarios. While traveling through ramps, undulating terrain, and making lane changes, the true component of the acceleration is extracted from the raw accelerometer signals with the help of change in attitude information from gyroscopes. This significantly reduces errors in distance approximation.

FIG. 10 depicts the processing of the raw signal from the accelerometers according to the method 800 described herein. First, the raw signals are passed through a 2^{nd} order Butterworth filter. Then the median is computed over a window of 20 samples. Finally, the mean is calculated over 10 medians. This extracts the trend of driving and yields only one acceleration value for a second.

FIG. 11 illustrates the correlation of stopping estimates with traffic light positions. The “no” symbols appearing horizontally across the center of the figure denote stopping positions. When matched to road segments A and B, road segment B is pruned due to the absence of traffic lights at stopping positions.

FIGS. 12A and 12B depict a method of calculating a transitional probability according to one embodiment of the invention. The burglar's car takes a turn on road segment j from i and travels a distance d before turning onto another road segment k. Distance traveled d is obtained using the accelerometer and ε_{d} is the error range associated with computing d. The two road segments falling within error range ε_{d} and allowing a turn are road segment k=1 and k=2. Hence, the road segments traveled on j could be either j=1 or j=2. The HMM computes the transitions probabilities for j=1 or j=2 and moves onto road segment k.

FIG. 13 depicts the use of the margin of error ε_{d} to compensate for stoppings that do not precisely coincide with traffic lights. Once a traffic light is found within the error range, the stopping estimates are refined by pinning to the traffic light.

FIG. 14 depicts the operation of the matching algorithm when multiple traffic lights are detected within the same error range. If multiple traffic lights are detected within the same error range, the matching algorithm forks into multiple branches, one for each plausible traffic light. Finally, the sequence of traffic lights that generates the highest emission probability is accepted.

FIG. 15 is a bar graph comparing the error percentages for angle estimation without offset to account for drift with the error percentages for angle estimation after correcting for drift.

FIG. 16 is a bar graph depicting the error percentages for distance estimates when omitting various elements of methods described herein. Testing was performed over the following six different driving conditions: straight road (“strt”), stop-and-go traffic (“s-go”), travel with frequent lane changes (“ln-ch”), travel with frequent change in speeds (e.g., rapid acceleration and deceleration) (“v-sp”), travel on hilly roads (“hill”), and travel on roads with frequent (often sharp) bends (“bend”). The first (leftmost) bar in each group depicts the actual error in distance estimates when all stages of method 800 are employed. The second bar in each group depicts the error percentage if reorientation (step S808) is not employed. The third bar in each group depicts the error percentage if radial acceleration is not accounted for in step S816. The fourth (rightmost) bar in each group depicts the error percentage if drift is not accounted for in step S818.

FIG. 17 depicts the cumulative distribution of distance approximation errors for 300 segments ranging from 0.2 to 1.5 miles.

FIG. 18 depicts the probability of obtaining the correct path using Viterbi decoding when the distance between successive stops and/or turns are used together with total length of path segment are used for observables, destination location is known with 100 meter uncertainty, and initial location is known with 500 meter uncertainty. The x-axis denotes the error in distance estimation.

FIG. 19 depicts the probability of obtaining the correct path using Viterbi decoding using the parameter discussed in the context of FIG. 18, but with cellular tower localization available at each turn.

FIG. 20 depicts the probability of obtaining the correct path using Viterbi decoding using the parameter discussed in the context of FIG. 18, but without the use of distance between stops as an observable.

FIG. 21 depicts the probability of obtaining the correct path using Viterbi decoding using the parameter discussed in the context of FIG. 18, but with the incorporation of highways in the path.

FIG. 22 depicts the cumulative probability of obtaining the correct path in the top k-weighted paths in the scenario depicted in FIG. 21.

FIG. 23 depicts the probability of obtaining the correct path using Viterbi decoding using the parameter discussed in the context of FIG. 21, but with cellular tower localization available at each turn.

### DESCRIPTION OF THE INVENTION

Embodiments of the invention provide theft detection systems and methods.

Ideally, a theft detection system should be affordable, have minimal compliance requirements from the owner (e.g., no need for battery recharging, reporting, and the like) and have a very low false alarm rate. In addition, detection of burglary incidents should be autonomous and timely so that burglars can be caught with the evidence of crime, making arrest, investigation, prosecution, and recovery of stolen items simpler and less expensive. Finally, in order to lead to the arrest of burglars (rather than deter them), the burglars should not be able to determine whether an asset is tagged. Otherwise, burglars may steal only unprotected assets to evade capture.

By including the ability to not only estimate the current location of a stolen asset, but also reconstructing the path of travel of the stolen asset, embodiments of the invention advantageously allow not only for the recovery of tagged assets, but also can provide law enforcement authorities with valuable information regarding of the structure of burglary operations including, for example, locations where stolen assets are stored or “fenced” for later resale.

### System Architecture

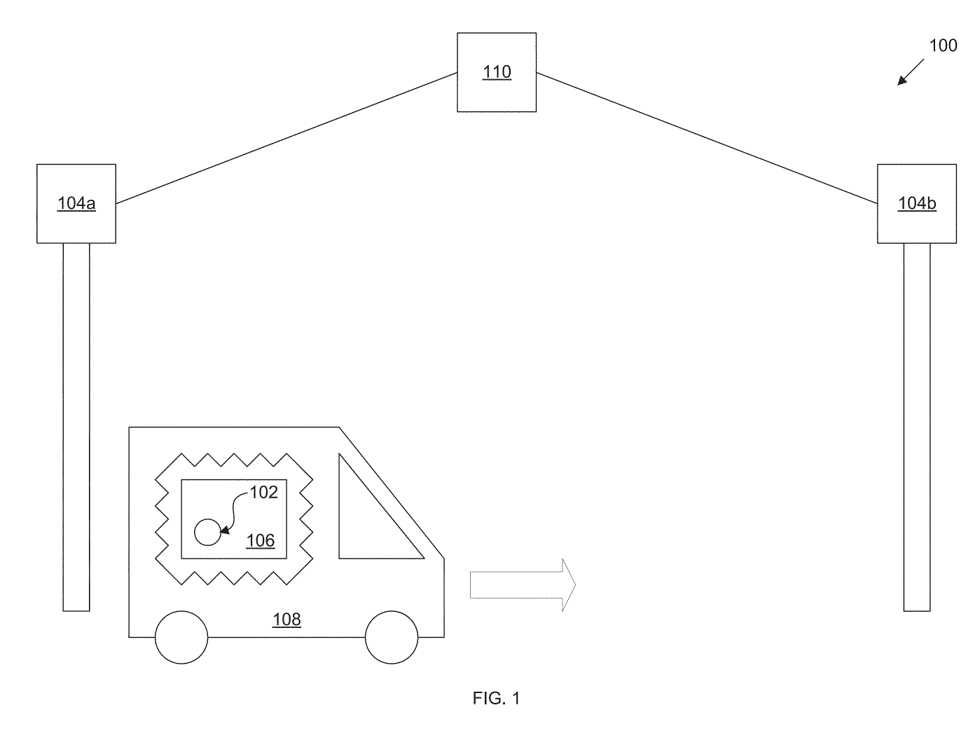

Referring to FIG. 1, one embodiment of the invention provides a theft detection system 100 including (i) a tag node 102 that is attached and/or placed within assets 106 for automatic theft detection at a low cost and on ultra-low energy and (ii) a server 110 programmed to determine a path traveled by an stolen asset 106 containing the tag node 102. Tag node 102 can communication with server 110 via a plurality of anchor nodes 104 which can be existing cellular telephone transceivers or other commercially-available or specially transceivers to track the movement of stolen assets 106 in real-time.

Embodiments of the invention autonomously detect the theft of assets 106 without requiring reporting from its owner. Embodiments of the invention then provide real-time updates on the current location of fleeing suspects to law enforcement personnel. Embodiments of the invention emphasize low cost, energy-efficiency, and compliance-free usage.

One embodiment of the invention includes a battery-powered tag node 102 for attachment to assets 106 that are likely to be stolen and a city-wide set of anchor nodes 104 that enable energy-efficient tracking in real-time. The tag nodes 102 are to be hidden in assets 106 such as televisions, audio equipment, antiques, pianos, desktop computers, washers, dryers, HVAC units, and the like that are not moved frequently in vehicles 108. Since burglary usually occurs in the absence of the owners, these assets 106 are more likely to be left in a dwelling and taken by a burglar.

Embodiments of the tag node 102 consume extremely low amounts of power so that the tag node 102 can last about ten years on a standard coin cell battery. Embodiments of the tag nodes 102 are also ultra low cost so each user may purchase dozens of tag nodes 102. Embodiments of the tag nodes 102 also have a small footprint so that they can be hidden easily in a wide variety of assets 106.

Embodiments of the tag node 102 detect theft autonomously using a hierarchical wake-up system of passive and active vibration sensors. The transceiver of the tag node 102 is turned off unless a theft event has indeed occurred, and the stolen asset 106 is being driven on the street, to keep theft detection stealthy and energy-efficient. The vibration sensor on the tag node 102 can also be leveraged for several other tasks including in a novel procedure for arming/disarming of the tag node 102 as discussed in International Publication No. WO 2011/011405.

In one embodiment, anchor nodes 104 are deployed on roadways to enable low cost and energy-efficient tracking of the stolen asset 106 in real-time. For example, the existing cellular telephone infrastructure can be leveraged to provide near universal coverage.

Anchor nodes 104 can with server 110 through a variety of means. For example, server 110 can be connected to the Internet and tag nodes can send (via anchor nodes 104) in a variety of formats including Short Message Service (SMS), e-mail, Hypertext Transfer Protocol (HTTP), and the like. The server 110 can be monitored by a law enforcement agency or a third party (e.g., a private security company) for the monitoring of messages forwarded by anchor nodes 104 from tag nodes 102 and coordinating an appropriate response.

### Tag Nodes

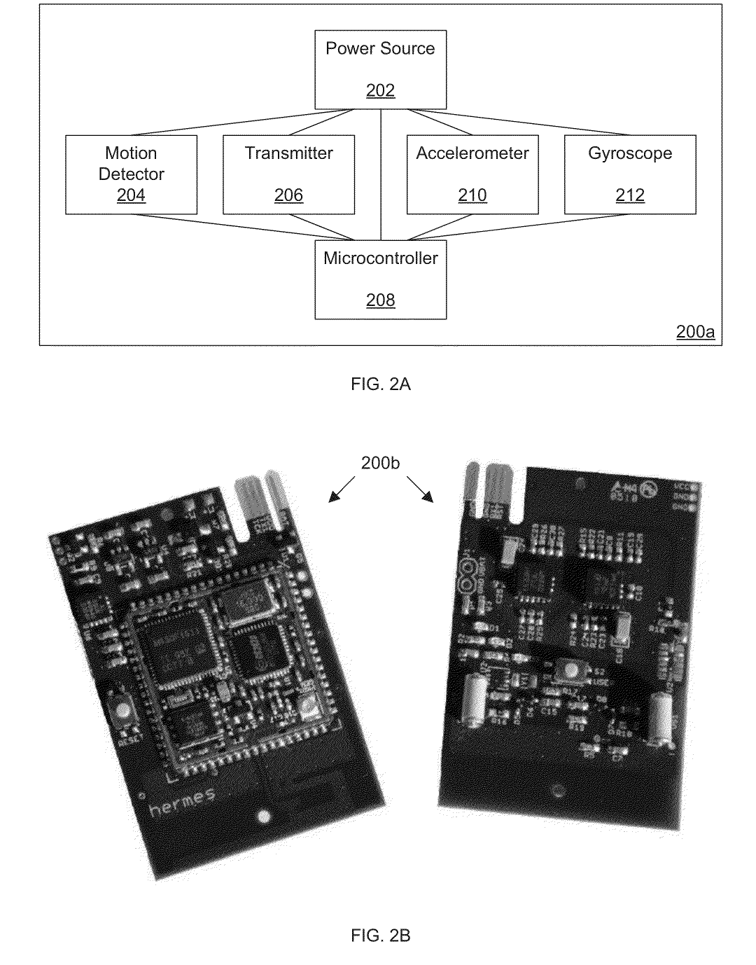

Referring now to FIG. 2A, an embodiment of a tag node 200a is depicted. The tag node 200a includes a power source 202, a motion detector 204, a transmitter 206, and a microcontroller 208. The motion detector 204, transmitter 206, and microcontroller 208 are each coupled to the power source 202. The motion detector 204 and transmitter 206 are also coupled to the microcontroller 208.

The internal structure of an assembled tag node 200b according to one embodiment of the invention is depicted in FIG. 2B.

### Power Source

Power source 202 is preferably a battery in order to eliminate the need to connect the tag node 200 with an external power source, thereby allowing the tag node 200 to be less obtrusive, and permitting the tag node 200 to function once the stolen asset 106 in which the tag node 200 is hidden is removed from owner's dwelling. A variety of batteries can be used as will be appreciated by those of skill in art. The key battery selection criteria are self-discharge rate (which affects shelf-life), energy density (which affects size), and cost (which affects viability).

The common lithium manganese dioxide (LiMnO2) primary cell provides a good mix of features well-suited to this application. Such batteries exhibit a shelf-life of over 10 years at room temperature and are often used as a permanent component for the entire lifetime of electronic systems. Their bulk volumetric energy density is approximately 600 mWh/cm³, although for some small batteries like photo/coin cells, the effective volumetric energy density can be lower due to packaging overhead. Commonly-available lithium coin cells in the CR family, such as the ENERGIZER® CR2032 battery, available from Eveready Battery Company, Inc. of St. Louis, Mo., are widely-used in consumer products, making them relatively inexpensive.

Although alkaline primary cells also have low self-discharge rates, their volumetric energy density is half of the lithium primary cells, which increases size, and their terminal voltage drop makes voltage regulation more important.

The ENERGIZER® CR2032 battery has a 10+ year shelf-life (losing only 15-20% of its capacity at room temperature), provides an energy density of 653 mWh/cm³ (supplying over 200 mAh in a 1 cm³ package), and is available for less than $1 through retail channels (and substantially less in bulk). These figures translate to an approximately 2.5 μA-decade/cm³ charge density, which suggests that the average current draw should be less than 2 μA to achieve a 10-year lifetime.

### Motion Detection

Motion detector 204 can be any device capable of distinguishing between an object at rest from an object in (prolonged) motion. Preferably, motion detector 204 draws less than 2 μA of current.

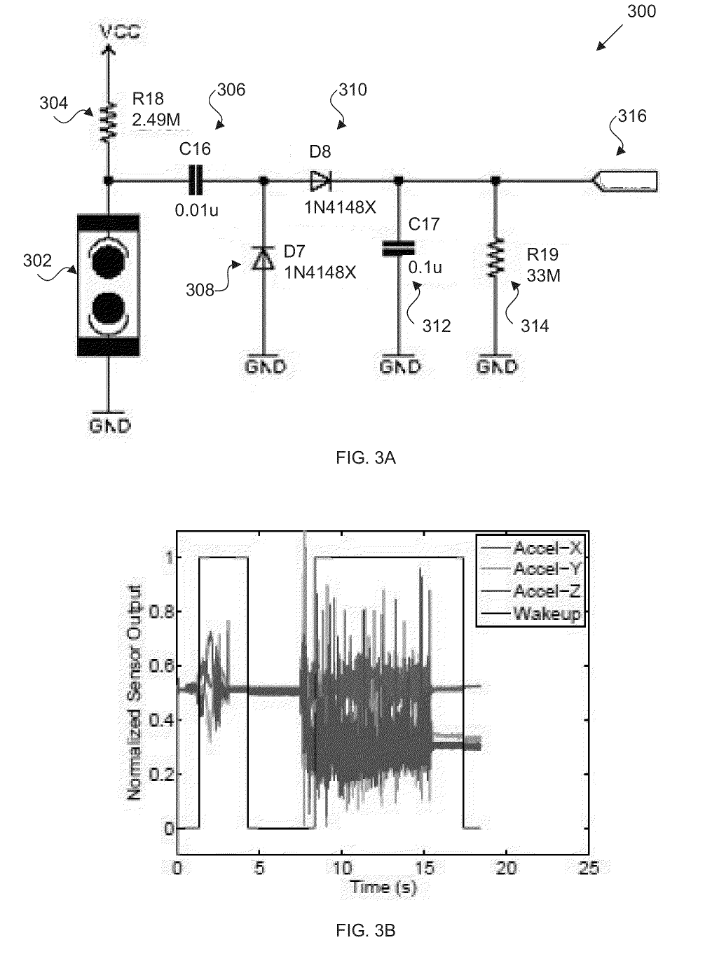

In one embodiment, motion detector 204 is a vibration dosimeter such as the vibration dosimeter 300 shown in FIG. 3A. The vibration dosimeter 300 includes an omnidirectional vibration switch 302 that is nominally closed at rest but chatters open and closed in response to movement. Suitable switches 302 include those in the SQ-SEN-200 series available from SignalQuest, Inc. of Lebanon, N.H. Switch 302 is connected to ground on one terminal and in series with a pull-up resistor 304 to power on the other terminal. The 2.49 MW pull-up resistor 304 sets the quiescent current draw of the circuit. At rest, the circuit draws 1.2 μA at 3 V. A capacitor 306 AC-couples the output of the switch 302, a first diode 308 steers negative voltage transients to ground, and a second diode 310 steers positive transients to a capacitor 312 that integrates these signals. A resistor 314 in parallel with the integration capacitor 312 slowly discharges the capacitor 312 so that in the absence of motion, the capacitor voltage goes to zero.

FIG. 3B shows the vibration dosimeter 300 in operation. Tri-axial acceleration samples taken at 200 Hz are shown with their bias removed and amplitude scaled. The output of the motion detection wake-up circuit 300 can be seen as a pulse that alternates between zero and one as the sensor transitions from rest to motion. At time t=0.5 seconds, a tag node 200 is picked up and moved and at time t=1.33 seconds, the motion detector circuit wake-up triggers, waking up the sleeping microcontroller 208 using interrupt line 316. At time t=3.09 seconds, the tag node 200 stops moving, and at time t=4.3 seconds, the motion detector output indicates movement has stopped. This process repeats for a second, longer, and more significant motion starting at time t=7.5 seconds.

In another embodiment, motion detector 204 is a piezo-electric vibratab that generates electricity to trigger an interrupt when vibrated. Suitable vibratabs include the MiniSense 100 vibration sensor available from Measurement Specialties, Inc. of Hampton, Va. and are described in publications such as Mateusz Malinowski, “CargoNet: Micropower Sensate Tags for Supply-Chain Management and Security” (February 2000) (Master's Thesis) (Mass. Inst. of Tech. Elec. Eng. & Comp. Sci. Dep't); and Mateusz Malinowski et al., “CargoNet: A Low-Cost MicroPower Sensor Node Exploiting Quasi-Passive Wake-up for Adaptive Asynchronous Monitoring of Exceptional Events,” in “Proc. 5th Int'l Conf. on Embedded Networked Sensor Systems” 145-60 (November 2007).

### Transmitter

Transmitter 206 is preferably a radio transmitter. In some embodiments, transmitter 206 is only capable of sending data. In other embodiments, transmitter 206 is a transceiver capable of both sending and receiving data.

In some embodiments, transmitter 206 is a low-power transmitter in accordance with the IEEE 802.15.4 standard. Such devices include the CC2420 2.4 GHz transceiver available from the Chipcon Products unit of Texas Instruments of Dallas, Tex.

In other embodiments, transmitter 206 can be configured to communicate with existing cellular towers using various standards such as the Global System for Mobile Communications (GSM), General Packet Radio Service (GPRS), Code Division Multiple Access (CDMA), Evolution-Data Optimized (EV-DO, Enhanced Data Rates for GSM Evolutions (EDGE), Digital Enhanced Cordless Telecommunications (DECT), Integrated Digital Enhanced Network (iDEN), and the like.

In some embodiments, transmitter 206 can be a GSM/GPRS cellular radio modem such as the TELIT® GM862 or GE865 modules available from Telit Communications S.p.A. of Sgonic, Italy. The TELIT® GM862 module includes an onboard SiRF III GPS chipset, a SIM holder, and battery charger. Advantageously, the TELIT® GE865 module has a small footprint of 22 mm×22 mm×3 mm.

A separate carrier board can be used to mount the TELIT® GM862 or GE865 module and connect it with the remainder of the tag node 200a for power control and serial communications, external antennas for GPS and GSM/GPRS, and power. To support experimentation, an 1100 mAH, 3.7 V rechargeable Li+ battery provides power. For production purposes, a primary (non-rechargeable) battery may be preferred due to significantly lower leakage currents. Finally, the GPS uses a small, external, embedded antenna with integrated low-noise amplifier (28 dBi) (e.g., a V.TORCH VTGPSIA-3 Active Antenna available from SparkFun Electronics of Boulder, Colo.), while the GSM/GPRS radio uses an external, quadband blade antennae (1-2 dbi) (e.g., an S-blade quad antenna). However, a smaller, integrated antenna and radio module may be favored in production models.

### Microcontroller

Microcontroller 208 receives inputs from motion detector 204 and transmitter 206 and controls the operation of transmitter 206. Microcontroller 208 can be selected from a variety of commercially available devices including: the Atmega 128L, ATmega 1281, and ATmega 2561 models available from Atmel Corporation of San Jose, Calif.; the EM250 model available from Ember Corporation of Boston, Mass.; the HC05, HC08, HCS08, and MC13213 models available from Freescale Semiconductor, Inc. of Austin, Tex.; the JN5121 and JN5139 models available from Jennic Ltd of Sheffield, United Kingdom; the MSP430F149, MSP430F1611, MSP430F2618, MSP430F5437, and CC2430 models available from Texas Instruments of Dallas, Tex.; and the eZ80F91 model available from ZiLog, Inc. of San Jose, Calif. In some embodiments, the tag node 200 utilizes the “Epic Core” architecture (including the TEXAS INSTRUMENTS® MSP430F1611 microcontroller) described in Prabal Dutta et al., “A Building Block Approach to Sensornet Systems,” in “SenSys '08: Proc. 6th ACM Conf. on Embedded Network Sensor Systems” 267-80 (2008).

Microcontroller 208 is programmed to receive a wake-up signal from the motion detector 204, determine whether the tag node 200 is being transported by a motor vehicle, and if the tag node 200 is being transported by a motor vehicle 108, calculate information about the motor vehicle's path and instruct the transmitter 206 to transmit one or more messages to server 110.

The microcontroller 208 can also be programmed to periodically obtain a measurement of the residual energy in power source 202. If the residual energy is less than a predetermined threshold, the microcontroller 208 send a message to server 110 (e.g., via GSM radio). The server 110 can then alert the owner (e.g., via an automated email) of the need to replenish the power source 202 (e.g., by replacing one or more batteries).

### Accelerometer

In some embodiments, tag node 200 includes one or more accelerometer(s) 210. The accelerometer(s) 210 can be a plurality of accelerometers (wherein each accelerometer 210 measures acceleration in a single axs) or a multi-axis accelerometer 210 (e.g., a three-axis accelerometer 210). Suitable three-axis accelerometers include the ADXL330 available from Analog Devices, Inc. of Norwood, Mass.

### Gyroscopes

Tag node 200 can include one or more gyroscope(s) 212. The gyroscope(s) 212 can be a plurality of gyroscopes 212 (wherein each gyroscope 212 measures rotation about a single axis) or a multi-axis gyroscope 212 (e.g., a three-axis gyroscope 212.) Suitable gyroscopes 212 are available, for example, under model number LPR530AL/ALH from STMicroelectronics of Geneva, Switzerland.

The inertial system described herein can be fabricated without gyroscopes 212 if six accelerometers are aligned properly as discussed in C. Tan & S. Park, “Design of accelerometer-based inertial navigation system,” 54(6) IEEE Trans. on Instrumentation & Measurement 2520-30 (2005).

### System Integration and Power Optimization

An Epic Core tag node, a TELIT® GE865 GSM module, and the sensors were together in one compact platform. Several design choices were made to minimize the energy consumption when the tag is not being tracked, given that tracking is activated only when the tag is stolen.

The TELIT® GE865 GSM module uses a 2.8V CMOS logic level circuitry, while the Epic Core node has an MSP430 microcontroller that uses a 3.3 V logic level. Accordingly, any communication between the two units requires a logic level translation. Communication between the Epic Core tag node and TELIT® GE865 GSM module is of two types: the Epic Core tag node sends control commands and data to the TELIT® GE865 GSM module (which are finally sent as SMS messages to the AutoWitness server 110), and the TELIT® GE865 GSM module responds with status codes and other information such as cell tower IDs and signal strengths. Logic level translation can be done in several ways, such as using logic level translation chips, buffers with controlled output, voltage dividers, metal-oxide-semiconductor field-effect transistors (MOSFET), and resistor-based circuits. A voltage divider circuit is used for the transmit side from the Epic Core tag node to the TELIT® GE865 GSM module, which simply steps down the 3.3V to 2.8V. When not used, the microcontroller output can be kept in a high impedance state to minimize loss on the divider circuit. For the receive side, from the TELIT® GE865 GSM module to the Epic Core tag node, a MOSFET-based step up circuit was used, which takes both a 2.8 V and a 3.3 V input as references to convert a 0 V to 2.8 V signal to a 0 V to 3.3 V signal. The two reference signals are controlled by field-effect transistors (FETs), which act as switches and are turned on only when there is a need to communicate with TELIT® GE865 GSM module, namely when theft is detected. The on-off circuitry on TELIT® GE865 GSM module helps reduce power draw considerably by turning off the GSM circuitry, and is controlled by a line from the Epic Core tag node.

Even after using the On-Off circuitry, there are significant leakage current losses, which are minimized by a MOSFET-based switch that disconnects battery voltage from TELIT® GE865 GSM module.

The TELIT® GE865 GSM module also provides several other pins of interest including “Network Status LED,” “Power Monitor,” and “Jamming Detect Report” pins used in embodiments of the invention. The “Network Status LED” pin is an output line from the GSM module that indicates network activity and registration status by frequency of LED blinking. This signal is not used in the invention to drive an LED (which would waste around 3 mA of current); instead, it is used to count pulses to measure network activity without issuing a software command. The “Power Monitor” pin indicates whether the TELIT® GE865 GSM module has actually powered up or not by firing interrupts when powered on. The “Jamming Detect Report” indicates whether the GSM radio is being jammed. This information can be used to turn the GSM module off in the event of cloaking to preserve energy.

A simple parser was implemented on the Epic Core tag node to parse network registration and other information by issuing a software command to the TELIT® GE865 GSM module.

### Tag Node Deployment

The process of acquiring and deploying a tag node 102 is designed to minimize cost and user compliance. Users can purchase a tag node 102 over the Internet, receive one or more tag nodes 102 via postal or courier services, arm the tag node 102, hide the tag node 102 in assets 106 of their choice, and forget about the tag node 102. Alternatively, users can purchase tag nodes 102 from a retail store. If and when the user needs to transport a tagged asset 106 out in a vehicle 108, the user can either disarm the tag node 102 or remove the tag node 102 from the asset 106 before moving the asset 106.

Although embodiments of the tag node 102 are designed to last about ten years without recharging, its energy may be exhausted sooner due to factors such as frequent movement of the tag node 102 by the owner or due to being stolen and recovered. Consequently, a profile-based reminder system (similar to car service reminders sent by car dealerships) is provided in some embodiments. An energy profile estimator will be maintained at the service provider, who will use the time elapsed since deployment and time spent in the tracking state if a tag node 102 was stolen and tracked to estimate the remaining lifetime. The owner will be reminded to swap the tag node 102 for a newer tag node 102 with a new battery and possibly improved technology when the estimated lifetime crosses below a certain threshold (e.g., 20%).

### Tag Node Operation

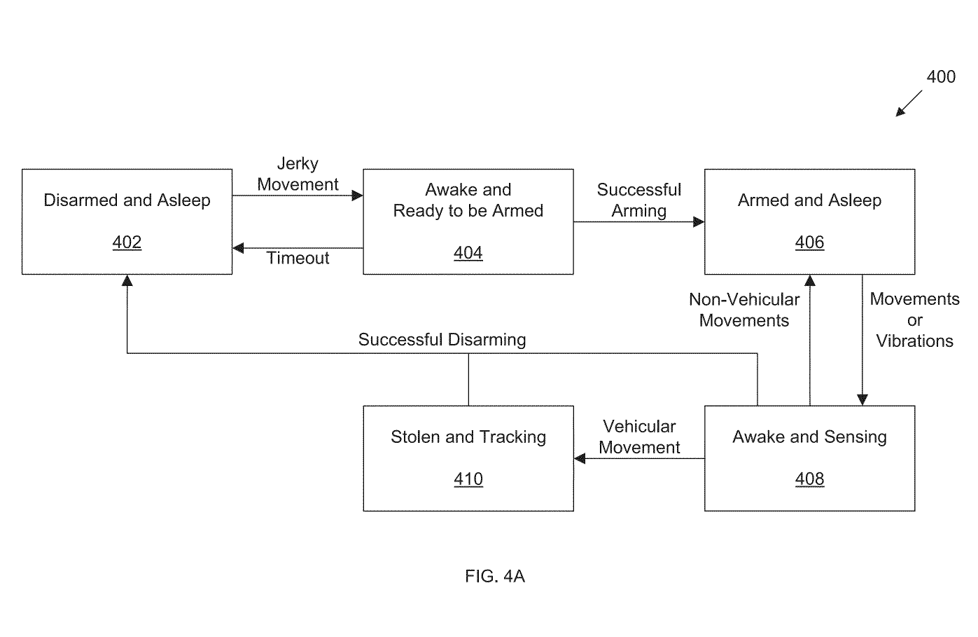

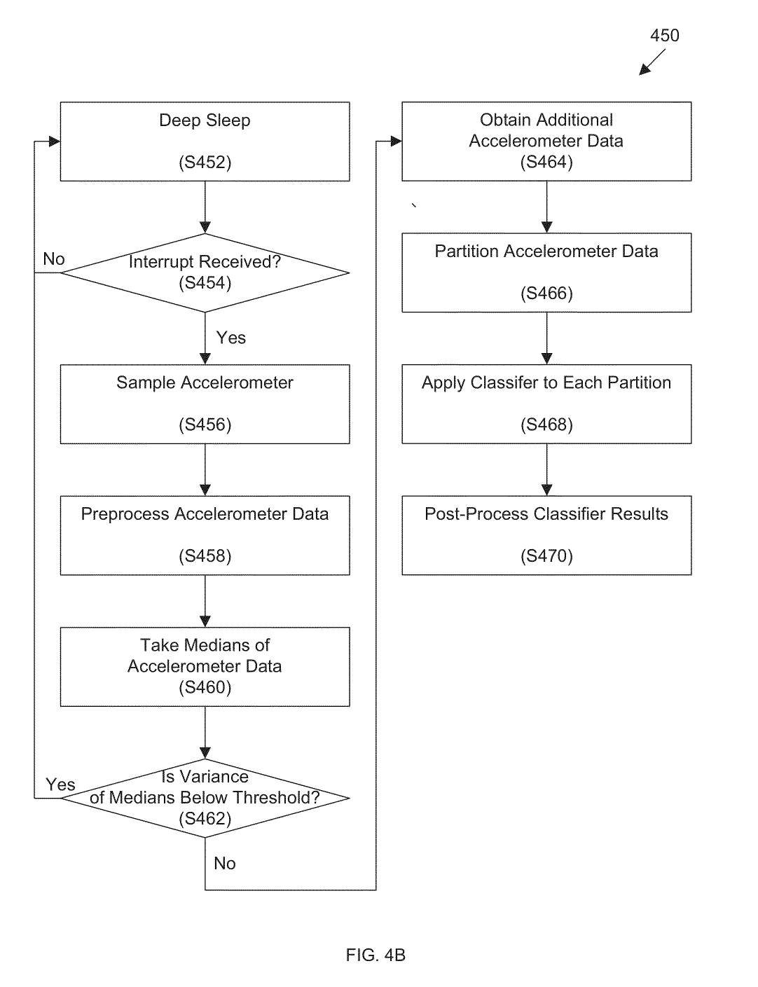

Referring now to FIG. 4A, a state transition diagram 400a depicts the operation of tag node 102 according to one embodiment of the invention.

Initially in state 402, a tag node 102 is disarmed and sleeping. When purchased, the tag node 102 can be shipped to a user without raising any theft alarm. Once a user receives the tag node 102, the user arms the tag node 102 before hiding it in an asset 106 that is likely to be taken in the event of a burglary.

The process of arming/disarming can utilize a novel mechanism of entering a multi-character password (e.g., a password chosen by the user while purchasing the tag node 102 online or a password generated automatically by the system) using an optional tilt sensor or accelerometer 210 in the tag node 102 as described in International Publication No. WO 2011/011405. Alternatively, tag node 102 can include an input device (e.g., a key pad) or can be armed using existing cellular telephone infrastructure (e.g., through an Internet portal).

Once armed, the tag node 102 enters a deep sleep state 406 (with just only motion detector 204 active).

Tag node 102 wakes up (state 408) when interrupted by the motion detector 204 as a result of significant movements such as jerks, displacements, and the like. Once awake, tag node 102 collects further readings of movement using accelerometer 210 and/or gyroscope 212 and runs a simple and efficient classification algorithm to determine whether it is being carried in a vehicle. Further details of the classification algorithm are described herein.

If the tag node 102 is not being carried in a vehicle, the tag node 102 returns to the armed and asleep state 406. Otherwise, tag node 102 enters into the stolen and tracking state 410 and seeks an anchor node 104 to notify a control device 110 of its theft and transmit information regarding the path of the motor vehicle 108.

When the stolen assets 106 are recovered, the recovered assets 106 can be returned to the owner, who can disarm (state 402) and rearm (states 404 and 406) the tag nodes 102 again to help catch any future burglar.

### Theft Detection

As discussed herein, tag nodes 102 can be hidden in assets 106 that are usually moved only in a vehicle 108. There are several phenomena that can be used to indicate that a tag node 102 (hidden in an asset 106) is being stolen.

In one embodiment, a tag node 102 can consider itself “stolen” upon being moved while the owner is not present (signaled by the absence of a master key such as a special tag node 102 or a mobile phone within communication range of the tag node 102). This approach would require the programming of a mobile phone and establishing compatible communication with various types of mobile phones. If a special tag node is used, then the special tag node must be carried by anyone wishing to move a tagged asset 106 from one room to another.

In another embodiment, a tag node 102 can consider itself stolen when the tagged asset 106 is taken outside of a marked zone. Such an approach requires use of some positioning technology (e.g., GPS, GPRS, and the like). Additionally, the user would need to update the system anytime the user moves to a new dwelling.

In still another embodiment, movement in a vehicle 108 serves as an indicator of a theft event if the tag node 102 has not been disarmed. Vehicle-movement-based theft detection is advantageous for at least two reasons. First, delaying the transition to state 410 (wherein the tag node 102 attempts to communication with anchor nodes 104) until the tagged asset 106 is moving in a vehicle 108 on a road preserves battery life while burglars may be collecting other items. Second, delaying communication allows the tag node 102 to evade detection by radio frequency (RF) scanners that may be used by sophisticated burglars.

In some embodiments, a tag node 102 does not consider itself “stolen” until it is driven in a vehicle 108 (as opposed to being carried by hand, for example when carried in an elevator or stairs). Such a tag node 102 would not send any message until the burglar has collected all assets of interest and begin to drive their vehicle 108. At this point, even if the burglar's RF scanner detects the radio transmission, it may be too late and the burglar may have invested too much effort into the burglary to abandon the attempt. Even if the burglar does attempt to unload his vehicle 108, unloading may be too cumbersome and the tag node 102 may have communicated with server 110 via an anchor node 104 during transportation.

A variety of classification algorithms exist to distinguish various human activities such as driving or riding in a motor vehicle from jogging, walking, and the like. See J. Lester et al., “A hybrid discriminative/generative approach for modeling human activities,” in “Proc. Int'l Joint Conf. on Artificial Intelligence” (2005). These algorithms make use of extensive machine learning techniques to automatically select the best features from a hundreds of features computed. These algorithms, however, require processing power of at least a mobile phone class device.

Since only classification of vehicle movement from all other types of movements is desired, a simple classifier is adopted in some embodiments. To obtain an algorithm that is efficient and accurate, a simple algorithm is first used to classify segments of about 250 ms either as:
static (S)—the tag node 102 is not moving;
walking (W)—the tag node 102 is being carried by a walking person; and
driving (D)—the tag node 102 is in a moving vehicle 108.
   To improve the accuracy of this simple classifier, this classifier is inserted into a simple sequential decision algorithm, inspired by the Sequential Probability Ration Test (SPRT). Let Cₜε{S,W,D} denote the decision of the simple classifier in segment t. Note that Cₜ is a random variable. Note also that the tag node 102 is assumed to have is woken up at the beginning of each segment. This should not constitute a loss in generality because the periods between wake-up signals are assumed to be long compared to T.

When a tag node 102 is woken up (state 408) at the beginning of segment t, it immediately samples the accelerometer 210 for about 250 ms and computes Cₜ. If Cₜ=S, the tag node 102 goes back to sleep (state 406). The logic behind this approach is that, if the tag node 102 is in a static vehicle 108, the tag node 102 will be woken up at a later time, when the vehicle 108 accelerates and otherwise no theft is occurring. This rule reduces the classification to a binary decision, between driving and walking. To make this decision, a sequential test that is based on the Sequential Probability Ratio Test (SPRT) is used.

Let H_{D} denote the null hypothesis that the tag mote is in a moving car, and H_{W} the alternative hypothesis that the tag mote is being carried by a walking person. For each time i, let cᵢ be the observed classification of segment i, and pᵢ^{D} be defined as P(Cᵢ=cᵢ|H_{D}) and pᵢ^{W} be defined as P(Cᵢ=cᵢ|H_{W}). According to the SPRT algorithm, a decision should be made at time s≧t, as soon as one of the following conditions is met:

$${\sum }_{i = k}^{s} [ log ( {p}_{i}^{D} ) - log ( {p}_{i}^{W} ) ] \geq {a}_{D} \to declare driving ; or$$

$${\sum }_{i = k}^{s} [ log ( {p}_{i}^{D} ) - log ( {p}_{i}^{W} ) ] \leq {a}_{W} \to declare walking .$$

The thresholds a_{D} and a_{W} are designed to achieve desired probabilities of false alarm and misdetection.

Obtaining the probabilities involved in this decision rule is not trivial. In fact, the measurements might not be independent and identically-distributed under the different hypothesis, which precludes the optimality of the SPRT method. Thus, the SPRT algorithm is used as a guide to obtain the following decision rule:
α_{D}|A_{s,t}^{D}|−α_{W}|A_{s,t}^{W}|≧a_{D}→declare driving; and
α_{D}|A_{s,t}^{D}|−α_{W}|A_{s,t}^{W}|≦a_{W}→declare walking;
   where A_{s,t}^{D}{i|cᵢ=D,i=t, . . . , s} and A_{s,t}^{W}={i|cᵢ=W,i=t, . . . , s}. Parameters α_{D}, α_{W}, a_{D}, and a_{W} are regarded as design parameters. Choosing α_{D}=α_{W}=1, a_{D}=2, and a_{W}=−2, defines the simple rule that, if two consecutive segments are classified as “walking,” then the algorithm declares that the tag node 102 is being carried by a walking person, while, if two consecutive segments are classified as “driving,” then the algorithm declares that the tag node 102 is in a moving vehicle 108.

Notice that the SPRT algorithm outputs a decision only when one of the two thresholds is reached. It might be the case that such thresholds are reached only after a long time. Such a case is regarded as a small probability event and accounted for by setting a maximum time, after which, if no threshold has been reached, the algorithm declares that no theft is occurring, and the tag node 102 goes back to sleep (state 506). The “no theft” decision can be favored to reduce false alarms and because it is expected that, if a theft is not caught immediately, as the vehicle 108 drives on, the tag node 102 will be woken up often enough to detect the theft at a later time.

To further reduce the number of false alarms, an additional rule can be added to the algorithm. Before declaring that a theft is in progress, the tag node 102 can sleep for a certain period of time T′. After waking up again after T′ seconds or after being woken up by the accelerometer before T′, if the tag node 102 detects a theft for the second time, only then does the tag node 102 issues an alarm. Otherwise, the tag node 102 restarts the algorithm and sleeps.

Embodiments of the initial classifier are now described in greater detail. A feature or set of features is selected that can be used to distinguish between a driving car and a walking person and an algorithm is provided to classify each segment based on such features.

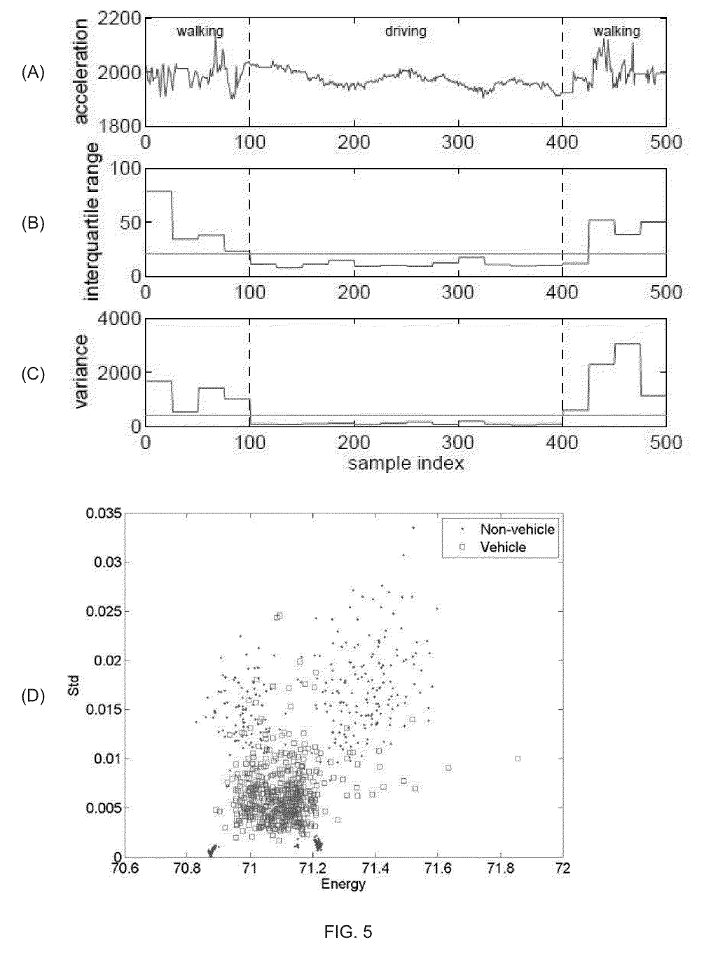

FIG. 5A depicts the acceleration signal obtained when a person takes an asset 106 containing a tag node 102 from the ground, walks with it, puts the asset 106 in a vehicle 108, drives the vehicle 108, takes the asset 106 from the vehicle 108, walks with the asset 106, and finally deposits the asset 106 on back on the ground.

FIGS. 5B and 5C depict the interquartile range and the variance, respectively, of a signal obtained from the acceleration measurements by computing the first difference, and then removing all the differences that are zero. The rationale behind performing this transformation before computing the features is that walking produces large and fast variations in acceleration, while driving produces slower, sustained variations, and computing the first difference will accentuate such difference.

As depicted in FIG. 5C, variance provides for a better separation. Experiments have shown that variance continues to provide for sufficient separation even when the accelerometer 210 is not oriented to the direction of movement. In some embodiments, accelerometer 210 is be “reoriented” to the direction of movement as discussed herein.

### Detecting Vehicular Movement

Referring now to FIG. 4B, one aspect of the invention provides an algorithm 450 for detecting if a tag node 102 is being moved in a vehicle 108.

A tag node 102 is in the deep sleep state (step S452) until an interrupt is generated by the vibration dosimeter 300 (step S454). After the interrupt, the accelerometer 210 is sampled for about 1.05 seconds at about 200 Hz (step S456).

The collected data can be preprocessed in step S458 by first converting the raw ADC values to acceleration in units of 1 g, then computing the magnitude of acceleration (in order to eliminate dependence of the algorithm on orientation of the tag node 102), and finally, computing the medians in non-overlapping windows of 15 samples (step S460).

In step S462, the variance of the computed medians is compared to a pre-defined threshold. If the variance of the computed medians is below a threshold, it can be assumed that the movement was caused by a short jerk, and the tag node 102 returns to a deep sleep state (step S452). If not, about 4.2 seconds of additional samples can be extracted in step S464 from accelerometer 210 to decide whether it represents vehicular movement. The 5.25 seconds worth of data can be partitioned in step S466 in five intervals of equal size and a decision tree classifier (for vehicular movement) can be applied to each interval in step S468, producing a total of 5 decisions. In a post-processing phase (step S470), majority rule can be applied to arrive at a final decision, i.e., if 3 or more out of 5 decisions are “vehicular movement,” the algorithm initiates tracking, otherwise it returns to deep sleep. Post-processing helps reduce the false alarms produced by transitions, for example, when the tag-mote is carried on foot.

To develop a classifier for vehicular movement, data was collected in different scenarios. A tag node 102 was attached to objects such as televisions and stereos, carried by a walking person, transported in car, on trolleys and rolling chairs. Classification is based on features computed from the data (after preprocessing), e.g., features found useful in the activity classification work such as S. Reddy, et al., “Using mobile phones to determine transportation mode,” 6(2) ACM Trans. on Sensor Networks 1-27 (2010). Different classifiers were trained in WEKA (available from WaikatoLink Limited of Hamilton, New Zealand) and evaluated using 10-fold cross validation. The performance of various classifiers are shown in Table 1.

TABLE 1
Performance of Different Classifiers
for Detecting Vehicular Movement
(using WEKA)

| Classifiers | Accuracy (%) |
|---|---|
| Decision Tree | 98.5813 |
| Random Tree | 98.4217 |
| Naïve Bayes | 87.5155 |
| Classification | 98.72 |
| ViaRegression | |
| Filtered Classifier | 96.1341 |
| Rotation Forest | 98.88 |
| Decision Table | 95.95 |

A decision tree was selected for some embodiments of the invention in view of its simplicity and was trained it with different number of features. The most discriminating features were energy (i.e., mean over square of measurements) and standard deviation. Adding more features did not lead to a significant increase in accuracy. FIG. 5D shows a scatter plot of feature values for vehicular and non-vehicular movement. This classifier achieved 97% accuracy, which improved to >99% by using majority voting as discussed herein.

One quantity of interest is the time it takes for the localization algorithm to be triggered after the tag node 102 is in a moving vehicle. Let λ be the average time between interrupts of the vibration dosimeter 300 (λ=1/9 seconds in the experiments conducted). Letting β denote the probability of false negatives of the classifier, the time to triggering the localization algorithm, when the vehicle 108 starts moving, is exponentially distributed with mean βλ. This means that theft will be detected with probability p=0.99 in, at most, T=−log(1−p)/(βλ)=41.7 seconds. After 2.08 minutes, the probability of false negatives is on the order of 10⁻⁶, which is negligible.

Estimating Distance and Turns from Inertial Sensors

After the system 100 classifies an activity as theft, a tracking module is triggered. The tracking module's purpose is to find the exact sequence of road segments that the stolen property is driven through so as to pinpoint its final destination.

The reconstruction of the path consists of two stages: (1) estimation of turns and distances between successive stops and/or turns and (2) application of Viterbi decoding and a Hidden Markov Model (HMM) on the street map to identify the path from distance and turn estimates.

### Obtaining Turn and Distance Measurements

Any rigid body's spatial movement in space can be described with the help of six parameters, namely, three translatory components (x-, y-, z-acceleration) and three rotatory components (x-, y-, z-angular velocity). As described earlier, the tag node 102 used herein can be equipped with a 3-axis accelerometer 210 coupled with a 3-axis gyroscope. The three acceleration sensors 210 and three gyroscopes 212 can be assembled such that they form an orthogonal system. The accelerometer 210 can have a 3-dimensional Cartesian frame of reference with respect to itself, represented by the orthogonal x, y, and z axes. In addition, a Cartesian frame of reference can be defined with respect to the vehicle 108 that the tag node is in. The vehicle's frame of reference is represented by the orthogonal X, Y, and Z axes, with X pointing directly to the front, Y to the right, and Z into the ground.

If the tag node's coordinate system was perfectly aligned with that of the car's, and the obtained signal from the tag was continuous integrating the individual translatory and rotatory components recorded on the accelerometers 210 and gyroscopes 212, respectively, would provide the exact position and attitude of the burglar's vehicle 108. For a straight road segment, a double integration of the acceleration data would yield the distance traveled from the starting point and, since the gyroscopes 212 provide output data representing rotation speed (not angular acceleration), a single integration of the gyroscope signal would yield the total change in the attitude of the burglar's vehicle 108. Performing these calculations periodically would enable the ideal system to trace the vehicle's movement with respect to a (virtual) reference point and to indicate its speed, current position, and heading.

However, the assumption of perfect alignment is unrealistic and in most cases when a theft occurs, the stolen object 106 will be placed in a tilted configuration resulting in an arbitrary disorientation of the axis of accelerometers with respect to the vehicle's coordinate system. Integrating readings from a disoriented accelerometer results in large estimation errors for both distance and angles. Additionally, the measurements obtained from low-cost inertial sensors are quite noisy and suffer from large drifts.

Methods of (i) obtaining angle estimates from the gyroscope measurements, (ii) reorienting the axes of accelerometers 210 every time there is a change in its orientation with respect to the vehicle, and (iii) estimating the distance traveled between successive stops and/or turns from accelerometer 210 and gyroscope 212 measurements are described herein.

Obtaining Angle Estimates from the Gyroscope

The gyroscope(s) 212 and accelerometer(s) 210 can be used to estimate the angle of change in the direction of movement of the vehicle. In strapdown inertial navigation applications, gyroscopes are used to estimate instantaneous attitude of the object along a fixed reference frame by a single integration of the angular velocity. The instantaneous attitude along each axis (X,Y,Z) can be represented using Direction Cosine matrix, Euler Angles, or Quaternions. The Euler Angle system is used in some embodiments to maintain the instantaneous attitude information.

Rate-grade, low-cost gyroscopes generally suffer from two kinds of errors—scale factor error and static bias. The scale factor error that can be introduced due to mounting and placement errors when putting the gyroscopes on the circuit board can be estimated once for each board using a turn table. Static bias is the output produced by gyroscope when there is no angular velocity applied to it. This value is often not a constant, and when integrated to find the angle of rotation may lead to large drifts over time.

This potential error can be accounted for by estimating the drift at every stop. Although the objective is measuring the change in the angle of heading of the vehicle 108 (for use in map matching), the tag node 102 may experience a change in orientation not only due to legitimate turns and curves in the road, but also due to change in its orientation from the vehicle's frame of reference (e.g., due to jerks or skidding when taking a turn).

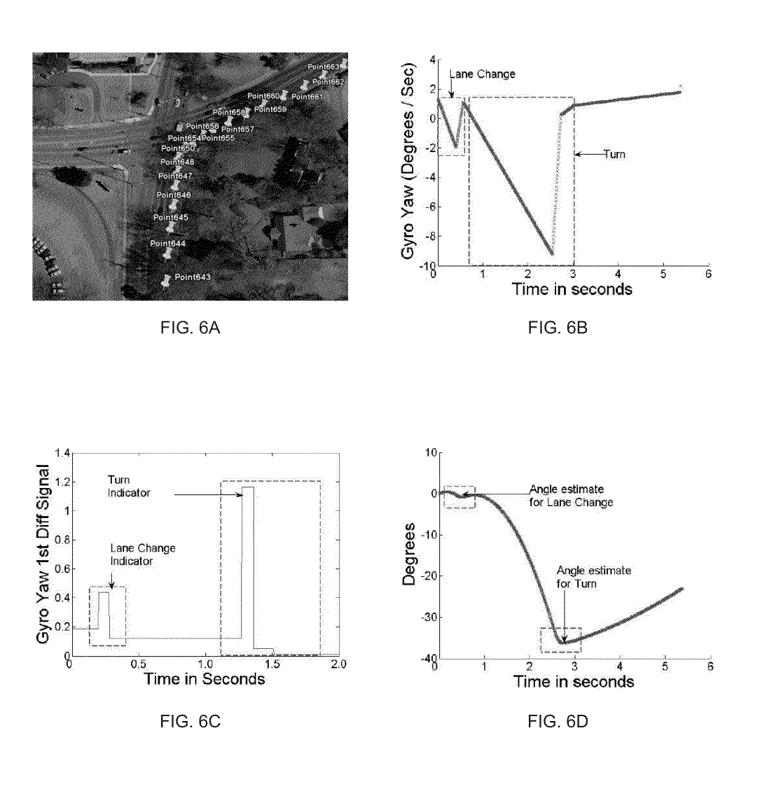

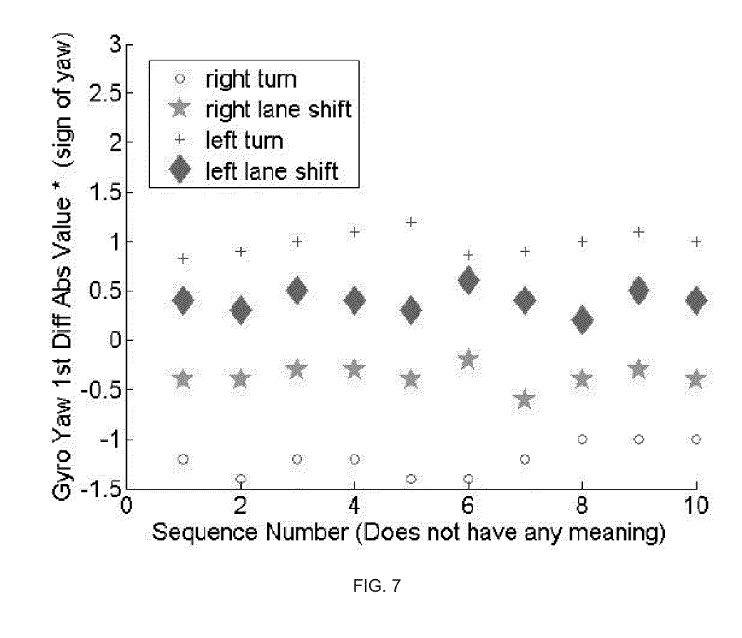

The absolute value of the first difference in yaw readings can be used to detect these changes in orientation. Two thresholds (Dₕ≧Dₗ) are maintained for amplitude so as to detect a spike in the first difference feature (when it rises above Dₕ) and record the time it takes for the first difference to return to normal (when it drops below Dₗ). This duration is called the activation time. FIG. 6 shows the effect of lane shifts and turns on these two features. Gyroscope measurements captured during the activation time can be used for computing the change in angle of the tag node 102. The axes of the accelerometer 210 cab reoriented to the vehicle's frame of reference using the reorientation module any time the gyroscope indicates a change in orientation (see “Reorientation of Accelerometer Axes” below). The change in the orientation of accelerometer 210 computed by the reorientation module (which represents the change in the tag's orientation from vehicle's frame of reference) is then accounted for in the angle of turn computed from gyroscope measurements to obtain the change in angle of the vehicle 108.

### Reorientation of Accelerometer Axes

To measure acceleration in the forward direction, the dominant (virtual) axis of the accelerometer 210 (which need not be aligned with any of the designated axes) needs to be determined so that the acceleration values used are indicative of distance traveled only. Since the tagged object 106 can be placed in any orientation, it is necessary to find the (virtual) axis of motion. In addition, the orientation of the tag node 102 may change en-route due to movement of the asset 106 that houses the tag node 102. The approach proposed in P. Mohan et al., “Nericell: Rich monitoring of road & traffic conditions using mobile smartphones,” in “Proc. 6th ACM Conf. on Embedded Networked Sensor Sysems (SenSys)” (2008) can be adapted determine the dominant axis. To determine when to reorient the virtual axis, gyroscope measurements were used instead of GPS signals (as used in Mohan et al.) because the tag node 102 may not have access to GPS signals.

Any arbitrary orientation of the accelerometer 210 can be arrived at by applying rotations about X, Y, and Z in sequence. Hence, the goal is to infer the angles of rotation about each axis. Reorientation is performed when the tag node 102 is in a stationary state. A stationary state can be detected using a simple threshold based detector that uses a moving average filter to clean the signal. Once a stop is detected, the accelerometer readings can be used to determine the orientation of the tag node 102 using gravity.

From that point, the orientation is maintained using the gyroscopes 212. Each time a stationary state is detected, the accelerometer 210 is again used to detect the orientation and correct the errors introduced over time by the gyroscope 212. A cosine matrix is used to resolve the accelerometer readings to a fixed reference frame as discussed in Titterton & Weston.

Estimating Distance Traveled from Inertial Sensors

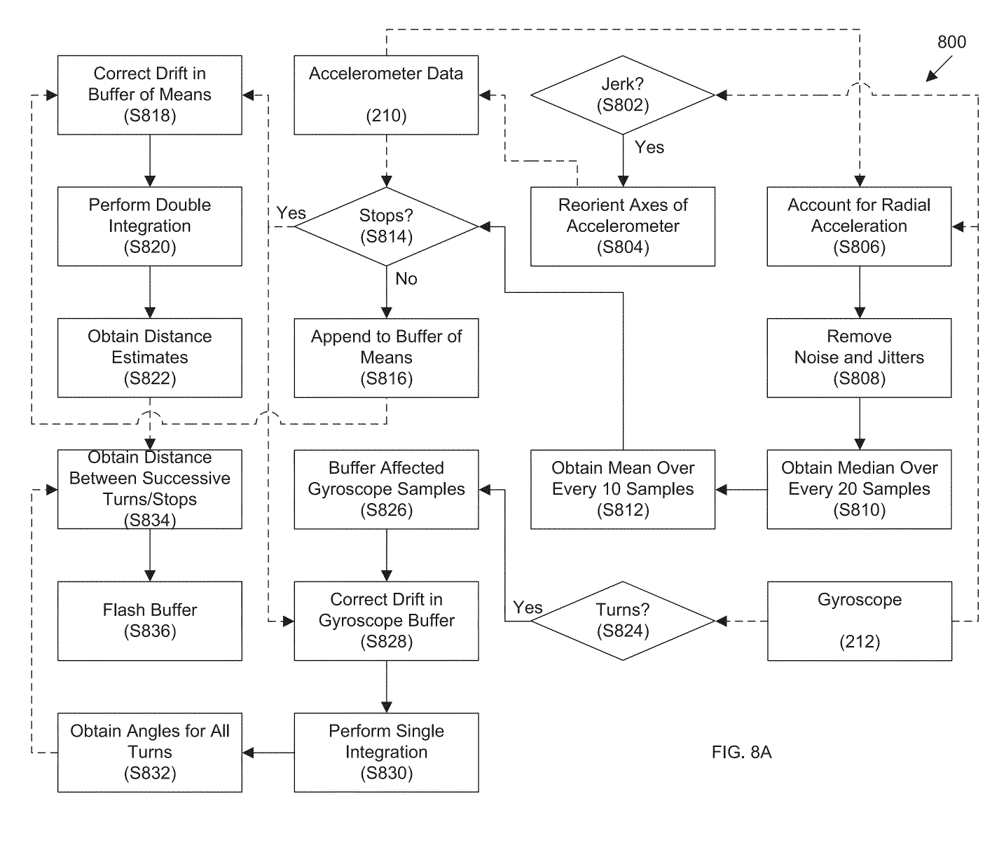

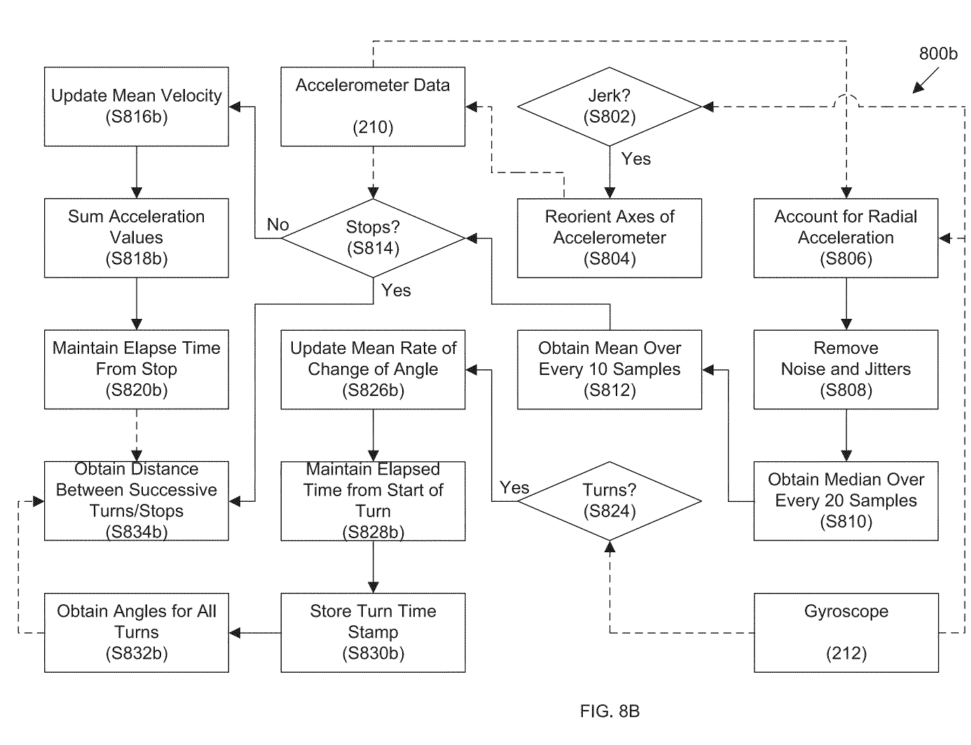

FIG. 8A shows the overall procedure 800 for obtaining distance estimates between successive stops. Data is obtained from accelerometer(s) 210 and/or gyroscope(s) 212 as discussed herein. If the gyroscope(s) 212 detect a jerk (step S802), the axes of the accelerometer 210 are reoriented in step S804. Thereafter, the output from accelerometer 210 can be assumed to be as if from a perfectly aligned tag node 102 inside the burglar's vehicle 108.

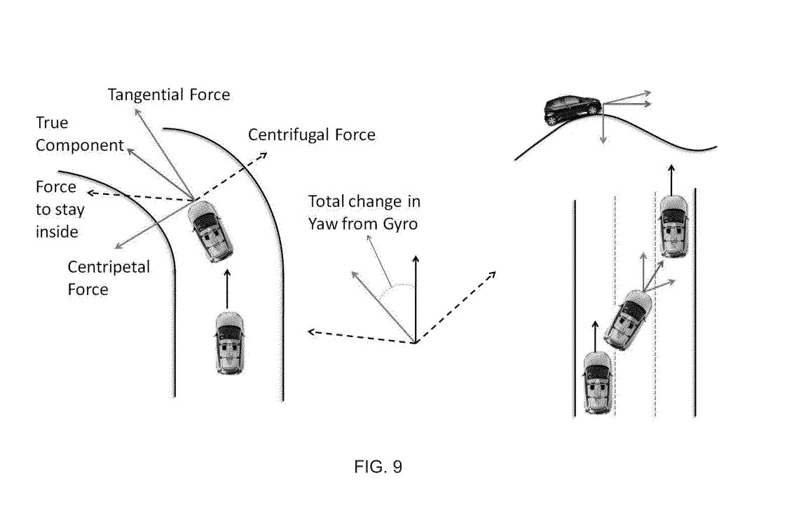

In step S806, the algorithm accounts for radial acceleration. Urban streets often contain curved roads through neighborhoods, ramps to highways, or loops. As shown in FIG. 9, when a vehicle 108 drives through a curved road even at small speeds, the centrifugal force can be substantial and the readings from the accelerometers 212 is actually a representation of the tangential acceleration generated by the vehicle 108. If the untransformed signal is integrated to find the distance traveled on the curved segment, it results in significant drift.

The true component of motion along the road is given by the resultant of the two opposing forces, namely, the tangential force and the centripetal force (or the force generated by the steering wheels to stay inside curve and the centrifugal force). In order to find the actual distance traveled on the road segment, one needs to extract the true acceleration component from the raw signal. This can be achieved with the help of gyroscopes 212. While moving into a curved segment from another road segment, the total change in yaw angle gives the angular rotation. The angular rotation can be then be used to find the component of centripetal force that, when subtracted from the raw signals, gives the component of acceleration along the curve. Other similar scenarios include lane changes and traveling over a hilly region or undulated terrain as shown in FIG. 9. Further details are provided in Chapter 11 of D. Titterton & J. Weston, “Strapdown inertial navigation technology” (2004).

When an object moves from one stop to the next stop, such as when accelerating from rest at a traffic light to coming back to rest at the next red signal, the average acceleration over the interval is zero. But during transit, the accelerometers 210 produce highly oscillating values. In order to eliminate the drift from the measurements, the mean acceleration (between two successive stops) is subtracted from all recorded acceleration values.

The typical speed limit of a vehicle 108 in urban scenarios lies below 75 mph, which is very small compared to the rotation speed of the earth's surface. Hence, the Coriolis Effect produced by the Earth can be ignored in the distance estimate computation.

To remove jitters and noise from the accelerometer(s) 210 in step S808, one can either perform a 2^{nd} order Runge Kutta Integration as discussed in J. Weston & D. Titterton, “Modern inertial navigation technology and its application,” 12(2) Electronics & Communication Engineering J. 49-64 (2000) or pass the signal through a 2^{nd} order Butterworth Filter as discussed in A. Lawrence, “Modern inertial technology: navigation, guidance, and control” (1998) and D. Titterton & J. Weston, “Strapdown inertial navigation technology” (2004). The latter approach produced better results in testing.

Due to the high sampling rate of the accelerometers (200 Hz) and jerks experienced on the road, the obtained signals still suffered from high amplitude variation. Hence, the signals were further smoothed by taking a median of 20 samples in a window (step S810) and then taking the mean of 10 such obtained medians (step S812). This procedure yielded only a single acceleration value for each second, representing the average trend of driving during that second.

In step S814, the mean is examined to determine whether the vehicle 108 is stopped. If the vehicle 108 is not stopped, the mean is appended to the buffer of the means in step S816. If the vehicle is stopped, any drift in the buffer of the means is corrected in step S818 according to the techniques described herein. In step S820, a double integration of the buffered means to obtain distance estimates in step S822.

In step S824, a turn is detected based on data from gyroscope 212. In step S826, the affected gyroscope samples are buffered. In step S828, any drift in the buffer of the gyroscope samples is corrected in accordance with the methods proposed in Mohan et al. and discussed above. In step S830, a single integration is performed over the buffered gyroscope samples to obtain angles for all turns in step S832.

In step S834, the estimated distance and angles are combined to obtain the distance between successive turns and/or stops. This information can be transmitted to another portion of the tag node 102, for example, for transmission to server 110. In step S836, the buffer is flashed to clears all stored data.

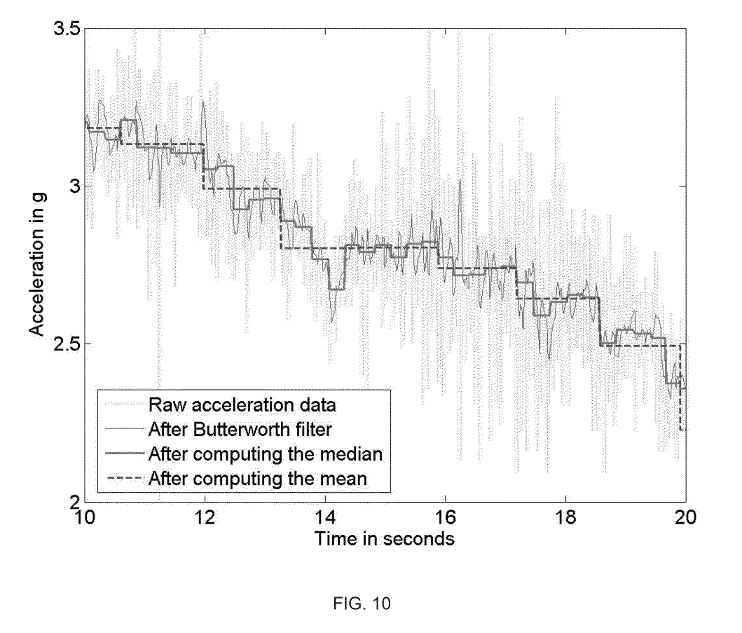

FIG. 10 depicts how the raw signals from the accelerometers are successively filtered to produce good distance estimates according the method 800 described herein.

In order to facilitate robust distance estimate in tag nodes having modest storage capacity (e.g., about 8 Kb), an alternate method 800b for obtaining distance estimates between successive stops is provided as depicted in FIG. 8B. This technique alleviates the problem of buffering large amounts of accelerometer data and still removes errors due to drift bias making a mote implementation for the invention feasible.

After filtering out noise (steps S806 and S808) and calculating one-second means of the acceleration data (steps S810 and S812), only the constantly-updated mean of velocity (step S816b), the sum of the accelerations (step S818b), and the time elapsed (step S820b) from the previous stop are maintained. A running mean is used to avoid estimation errors. The true distance d can be computed in step S834b using the formula d=( v̅−b*t)*t, where v̅ is the running mean of velocity, b is the sum of all acceleration values between successive stops, and t is the time elapsed from the previous stop.

A similar approach is utilized in steps S826b and S828b to measure turn angles from the gyroscope data. Additionally, step S830b stores the time stamp of each turn to divide the distances between successive stops into finer segments of distances between turns and/or stops. Generally speaking, the measured turn angles can have a lower accuracy than the measured distances between successive stops. Lower accuracy turn angle measurements can be utilized because most intersections have a limited number of turn paths (e.g., 2, 3, 4, 5, 6, 7, 8, and the like). Thus, the system often only needs to determine whether the vehicle turned left or right and does not need to be concerned with the precise turn angle.

Path Reconstruction from Distance and Turn Estimates

Once a sequence of turns and distances traveled between successive turns and/or stops is obtained, the next challenge is to search a map of streets to identify the sequence of road segments that is most likely to result into the observed sequence of distances and turns. The problem is especially challenging because: (1) the initial location of the tag node 102 may not be known deterministically due to the delay in activating the tracking module after theft is established by the theft classification module (of the order of 10 seconds, which may translate to 100 meters), (2) the estimates of distances obtained from accelerometer and gyroscope readings could be off from their actual values by up to 12%, (3) several road segments have similar lengths, and (4) the destination location may not be known deterministically (cellular-tower-based localization may have uncertainty of the order of 100 meters).

Viterbi decoding over a Hidden Markov Model (HMM) has traditionally been used for mapping noisy GPS measurements to a route because a route can be considered as a sequence of road segments and the adjacency among adjoining road segments can be used to constrain the transition among states (i.e., road segments). Therefore, even though this application does not have GPS coordinates to map to a sequence of road segments (contrary to most existing work on map matching), the formulation of an HMM continues to be a suitable choice due to its ability to leverage adjacency among road segments to account for the uncertainty in measurements.

An HMM is a Markov process comprising of a set of hidden states and a set of observables. Every state may emit an observable with a known conditional probability distribution called the emission probability distribution. Transitions among the hidden states are governed by a different set of probabilities called transition probabilities. Upon executing on a sequence of hidden states, an HMM produces a sequence of observables as its output. While the output (i.e., the list of observables) can be observed directly, the sequence of hidden states that were traversed in producing the observed output is unknown. The problem is to determine the most likely sequence of states that may have produced the observed output.

Viterbi decoding is a dynamic programming technique to find the maximum likelihood sequence of hidden states given a set of observables and the emission probability distribution and transition probabilities. Viterbi decoding is further described in A. Viterbi, “Error bounds for convolutional codes and an asymptotically optimum decoding algorithm,” 13(2) IEEE Transactions on Information Theory 260-69 (1967).

For map matching, hidden states usually correspond to road segments (portion of road between two points of interest, which could be intersections, not necessarily neighboring). The choice of observables is key to the formulation of an HMM. The definition of observables can aid Viterbi decoding in distinguishing one road segment from all others. Accordingly, the observables should be as unique to the road as possible. Exemplary observables considered in embodiments of the invention include average speed, total length of the segment, travel time, stretch of the segment (i.e., ratio of Euclidean distance between the two ends and the road length), among others. Some are not as unique, while others are not stable (e.g., travel time).

Two features were selected as observables: distance between successive stops and total length of the segment (between successive turns that indicate transition to the next road segment). Both of these features are simple to compute from the distance measurements, and together are rather unique to a road segment if it is sufficiently long (i.e., if it includes some stops). Although a vehicle may not stop at all traffic lights on a road segments, the distance traveled between successive stops at (red) traffic lights creates a pattern that can be (probabilistically) matched to a road segment as depicted in FIG. 11. The total length of the segment complements the distance traveled between successive stops by ensuring that the aggregate of the distance between successive stops for an entire road segment matches with the total length of that segment.

The starting state consists of all intersections within a radius of r from the location where the tag node was deployed before theft. The intersections are assigned uniform probability, i.e., 1/n, where n is the number of candidate intersections.

A transition is initiated only when a turn is indicated from the gyroscope measurements, in which case the distance traveled on the preceding segment and the angle of turn are used to determine the transition probability. To limit the number of states considered for transition, embodiments of the invention can consider only those states as likely within the error distribution of the observed length and turn.

Referring now to FIG. 12A, the transitional probability from a road segment i completed at the (t−1)^{th} turn to segment j completed at the t^{th} turn is derived using Bayesian inference. For a distance d traveled on road segment j before turning to another road segment k, the transition probability is denoted as Pᵢ(j|d) (for transition from state i to state j) and computed using methods 1200 as further explained below:

In step S1202, data regarding is provided regarding turn t. Such data can include, for example, accelerometer and/or gyroscope data associated with the turn t.

In step S1204, if t=1, this is the first turn observed after the detection of theft. In this case, the start state is defined in step S1206 as described herein and the method 1200 returns to step S1202 to await data regarding another turn t+1.

For t>1, the angle of turn (γ) is computed from gyroscope in step S1208 as described herein.

In step S1210, the distance traveled on the j^{th} segment (d) is computed using the accelerometers and gyroscope as described herein.

Since d and γ are estimations of the actual measurements, error margins ε_{d} and ε_{γ}, are associated with d and γ, respectively, in step S1212.

In step S1214, for all the road segments that begin at the end of segment i, and have a length between d±ε_{d}, (which all may be different portions of the same road), prune all the road segments j, whose angle of intersection with some road segment k is outside the range γ±ε_{γ}. (Once state i is defined, the angle of turn observed at the (t−1)^{th} turn determines the road whose segment may come next and thus limits the search for the next road segment on to this road.) The set of remaining road segments j are the candidate set for transition and is denoted as C (as depicted in FIG. 27B).

In step S1216, for all road segments in C, the prior probability Pᵢ(j) is uniform and is given by

$${P}_{i} ( j ) = \frac{1}{\vert C \vert} .$$

In step S1218, the evidence for Bayesian inference, Pᵢ(d|j), is estimated from experimentation. It is assumed that Pᵢ(d|j) follows a Gaussian distribution whose variance s depends on how accurately distances traveled on road with the help of accelerometers and gyroscope are approximated. Hence,

$$P ( d \vert j ) = \frac{1}{σ \sqrt{2 π}} {e}^{- {( d - {d}_{j} )}^{2} / 2 {σ}^{2}}$$

where dⱼ is the actual length of road segment jεC from start of road segment i.

In step S1220, the marginal probability P(d) is computed according to the formula P(d)=ΣP(j)P(d|j).

In step S1222, the transition probability is computed, which is given by the conditional probability.

$$P ( j \vert d ) = \frac{P ( d \vert j ) P ( j )}{P ( d )} .$$

Emission probability (i.e., the probability of seeing defined observables given that the system is in some particular state) is now discussed. These probabilities in practice should reflect the characteristics of a state, and are used by the Viterbi algorithm to differentiate the true state that the system is in from other probable states. If the stopping estimates were perfect, an emission probability of 1 could be assigned to the road segment whose traffic lights matched with the stopping distances and 0 to others. However, the estimations of distance obtained from accelerometers and gyroscope have a margin of error. Additionally, a vehicle may stop some distance earlier than the traffic light (e.g., if there are other vehicles in front of it). Therefore, assume that if the distance estimated is d, the true distance could have a range of d±ε_{d}. Let P(y|x) denote the probability of obtaining x from distance estimation when the true distance is y. For |y−x|>ε_{d}, P(y|x)=0; otherwise, P(y|x) is uniform over the entire domain.

The use of

$$P ( y \vert x ) = 1 - \frac{\vert y - x \vert}{y}$$

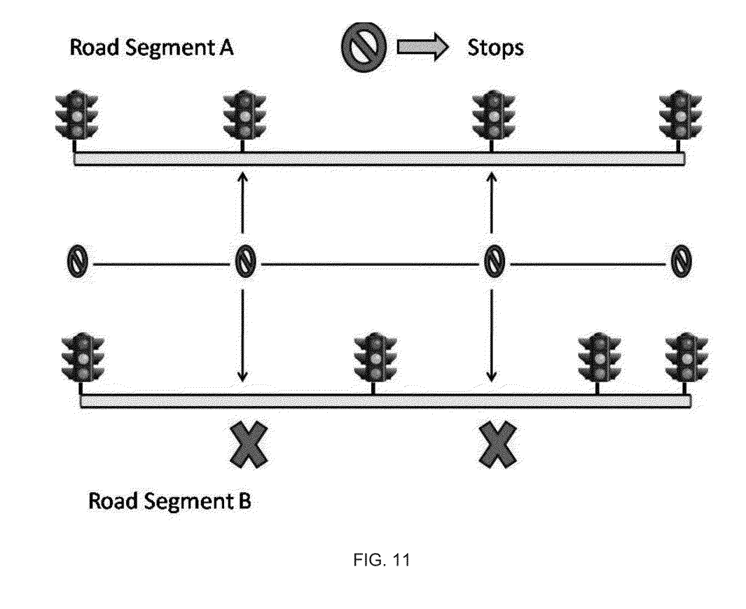

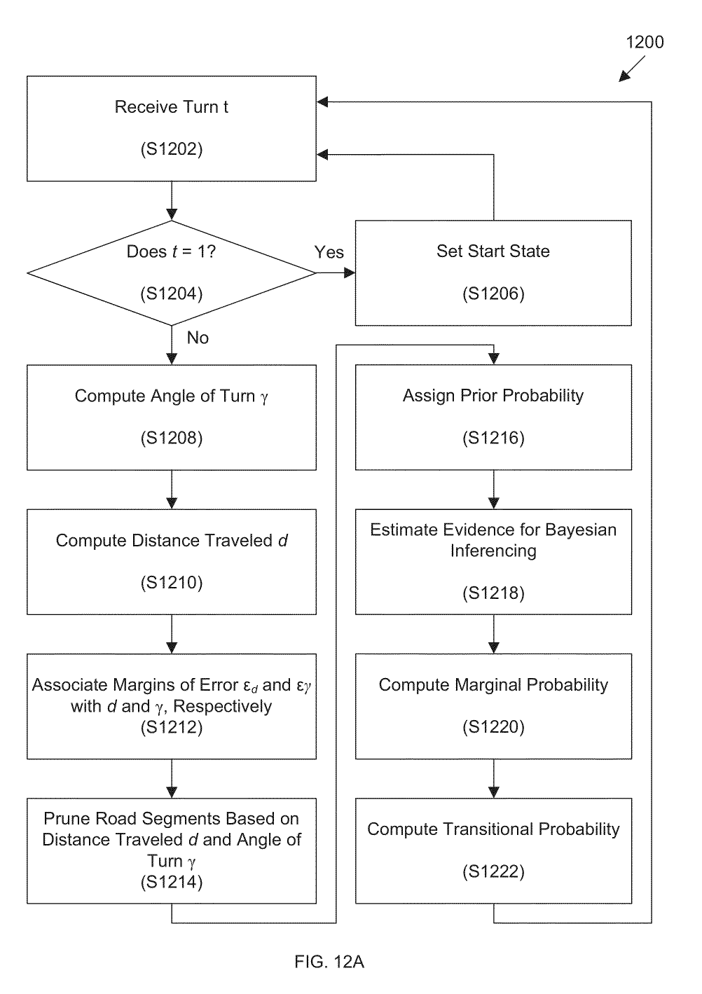

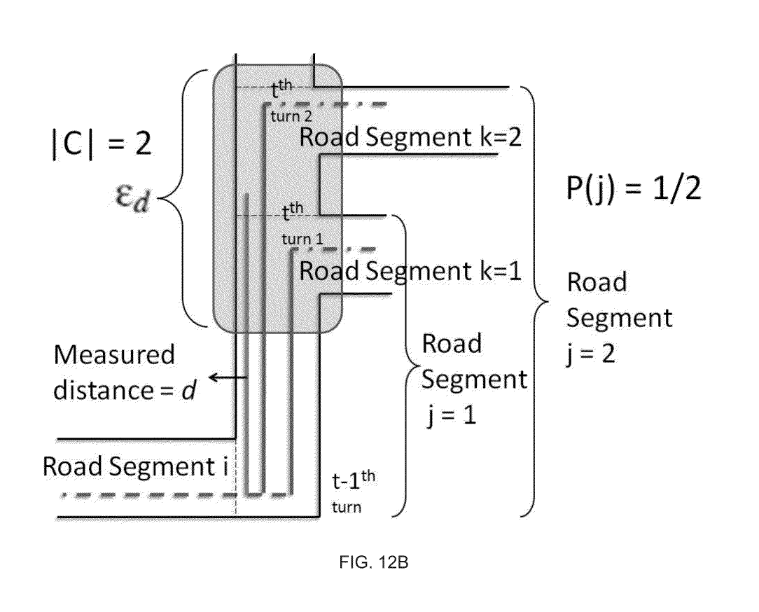

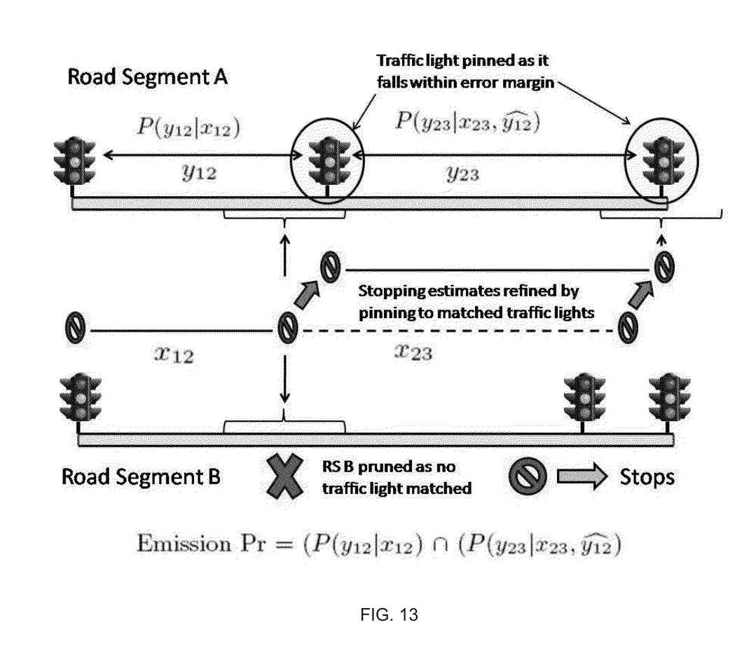

in computing the emission probability is now discussed. Consider a road segment s. Let the number of stops encountered be m, where the turn into this road segment is considered the first stop and the turn out of this segment to another road segment the last stop. Let x_{1,2} be the observed distance between stops 1 and 2 and y_{1,i}, the actual distance between traffic lights 1 and i, where 1≦i≦m and |y_{1,i}−x_{1,2}|≦ε_{d}. Each of these lights i become a candidate for the second stop. First, consider the case when there is only one candidate for i for each stop (see FIG. 13). Then, the emission probability P_{E}=P(y_{1,2}, . . . , y_{m-1,}m|x_{1,2}, . . . , x_{m-1,}m) for a sequence of observed distances in a given road segment is given by

$${P}_{E} = P ( {y}_{1 , m} \vert {x}_{1 , m} ) {\prod }_{i = 1}^{m - 1} P ( {y}_{i , i + 1} \vert {x}_{i , i + 1} ) .$$

If there are multiple candidate traffic lights for any stop i, then a new branch of traffic light sequence is considered corresponding to each candidate. A maximum is taken over the emission probability computed using the formula above for each candidate stopping sequence as depicted in FIG. 14.

### Working Example

### System Evaluation

Various aspects of the invention were evaluated as described herein.

### Evaluation of Theft Detection

The classifier described herein was implemented on a tag node 102 and data was collected from various conditions—vehicular movement, non-vehicular movement, and static (i.e., tag node 102 not moving). Static data was pooled in the category of non-vehicular movement. The total number of samples (each sample represents 210 accelerometer readings) used in the evaluation was 15,000. Vehicle movement data was obtained by placing the tag node 102 in a vehicle 108 and driving without stops. To obtain non-vehicular movement data, a person walked with the tag node 102 in her hand.

To obtain data from static situations in which the tag node 102 might wake up, the tag node 102 placed it on devices that may produce vibration such as televisions and speakers. The classifier was running on the tag node 102, and its output was logged.

Three versions of the decision tree classifier were compared. The first version was trained on raw accelerometer measurements, the second version used the medians over 15 samples, and the third version applies the majority rule over 5 decisions taken over the median of measurements. The results are presented in Table 2.

TABLE 2
Confusion matrices for three classifiers

| | Raw Data | | Median | | Median & Majority | |
|---|---|---|---|---|---|---|
| | | Non- | | Non- | | Non- |
| | Vehicle | Vehicle | Vehicle | Vehicle | Vehicle | Vehicle |
| Vehicle | 4916 | 84 | 4866 | 134 | 1000 | 0 |
| | (98.32%) | (1.68%) | (97.32%) | (2.68%) | (100%) | (0%) |
| Non- | 3557 | 6443 | 293 | 9707 | 29 | 1971 |
| Vehicle | (35.57%) | (64.43%) | (2.93%) | (97.07%) | (1.45%) | (98.55%) |

Notice that the number of samples in the rightmost confusion matrix is less than the corresponding number in the leftmost matrix, because the majority rule was applied to 5 consecutive segments of one second. Computing the median before extracting the features greatly reduces the number of misclassifications: only 2.93% of non-vehicle movement was classified as “vehicle,” and only 2.68% of vehicle movement was misclassified. Applying the majority rule eliminates false negatives entirely and limits false positive to <1.5%.

### Lifetime of the Tag Node

To evaluate the lifetime of the tag mote, let Ω denote the sample space containing all possible states that occur every time the tag mote wakes up. On this sample space, events T [symbol] M [symbol] Ω, denoting theft and object moving, respectively.

Let Hε{T,M\T,M^{c}} denote the event containing the true state, D_{d}ε{M,M^{C}} denote the decision of the movement detector, and D_{c},Dₘε{T,T^{c}} denote the decision of the movement classifier and majority rule, respectively. To simplify the notation, the following probabilities are defined:

p₁=P(D_{d}=M|H=M^{c}) q₁=P(D_{c}=T|H=M^{c},D_{d}=M)

p₂=P(D_{d}=M|H=M\T) q₂=P(D_{c}=T|H=M\T,D_{d}=M) (1)

Assuming, for simplicity, that decisions in different time intervals are independent, the following probabilities can be evaluated:

$$\begin{matrix}{Q}_{1} ( l ) = P ( {D}_{m} = T \vert H = {M}^{c} , {D}_{d} = M ) \\ = {\sum }_{k = [ l / 2 ]}^{l} ( \begin{matrix}1 \\ k\end{matrix} ) {{q}_{1}^{k} ( 1 - {q}_{1} )}^{l - k}\end{matrix} \qquad ( 2 )$$

and similarly for Q₂(l)=P(Dₘ=T|H=M\T,D_{d}=M) by substituting q₂ for q₁. Here, l is the number of decisions included in the majority rule (l=5 in the embodiments of the invention described herein).

The average energy consumed by the tag node when it is woken up by a short movement, while static, is given by

Eₛ=E+(l−1)p₁E+p₁Q₁(l)E′ₛ (3)

where E is the energy required to sample the accelerometer for 1.05 s and compute the decision from the data, and E′ₛ is the average energy consumed by the tracking algorithm before detecting that the object is not being stolen. The energy consumed when the tag node is woken up by a movement other than theft, such as when being carried by hand, is

Eₘ=E+(l−1)p₂E+p₂Q₂(l)E′ₘ (4)

where E′ₘ plays a similar role as E′ₛ in Equation (3). Combining Equations (3) and (4), the lifetime of the tag (in days) can be evaluated as:

$$L = \frac{{E}_{b}}{{N}_{s} {E}_{s} + {N}_{m} {E}_{m} + {E}_{0}} \qquad ( 5 )$$

where E_{b} is the energy of the battery, N_{S} is the number of times a day that the tag wakes up by a short movement, Nₘ is the number of times a day it wakes up by movement other than a vehicle, and E₀ is the energy per day drawn by the tag node during deep sleep. N_{S} and Nₘ are measured in wakeups per day and L is measured in days.

The following values of the probabilities involved in the analysis were obtained from collected data: p₁=0.0026, p₂=0.98, q₁=1, q₂=0.074. For l=5, Q₁(l)=1 and Q₂(l)=0.0037. The operation of the movement detector takes a total of 2.2 s, which includes 1.05 s of sample the accelerometer. The current drawn by the tag node during this time is dominated by the accelerometer (320 μA), ADC (800 μA), and microcontroller (550 μA). The charge consumed is

$$E = 1.05 \frac{320 + 800 + 550}{3600} + 1.15 \frac{550}{3600} = 0.66 μ Ah .$$

The energy (or charge) consumed by the movement classifier and majority rule is considered to be 1 times this value. Therefore,
Eₛ=0.66+(l−1)*0.66*0.0026+0.0026*1*E′ and
Eₘ=0.66+(l−1)*0.66*0.98+0.98*0.074*E′. The current drawn during deep sleep is at least 10 μA. Therefore, E₀=10*24=240 μAh. The energy of the batter is 200 mAh. Substituting these values in Equation (5) produces

$$L = \frac{200000}{{N}_{s} ( 0.67 + 0.0026 {E}_{s}^{′} ) + {N}_{m} ( 3.23 + 0.0036 {E}_{m}^{′} ) + 240} \qquad ( 6 )$$

The lifetime of the tag node can be estimated for given values of Nₛ, Nₘ, E′ₛ, and E′ₘ. For example, a tag node that is mostly static and is woken up by only jerks and not displacements (i.e., Nₘ≈0) can wake up up to 30 times a day, and assuming that E′ₛ (E′ₛ≦177 μAh), still have a lifetime of 2 years.

### Evaluation of Turn Estimation

The improvement obtained by estimating the bias at every stop was evaluated. Gyroscope measurements were collected by placing a tag node 102 in a car 108 and taking 120 turns for 6 values of angles. The ground truth was collected using GPS on an ANDROID™ G1 phone.

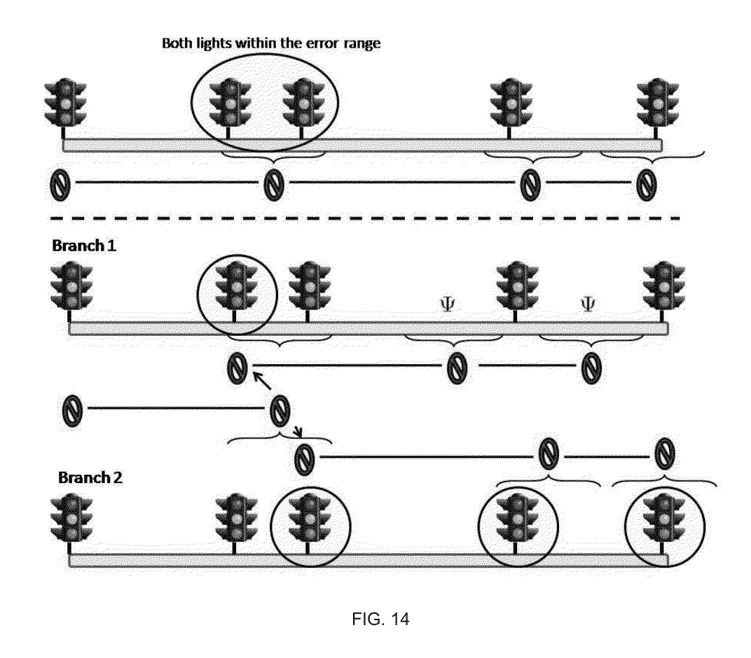

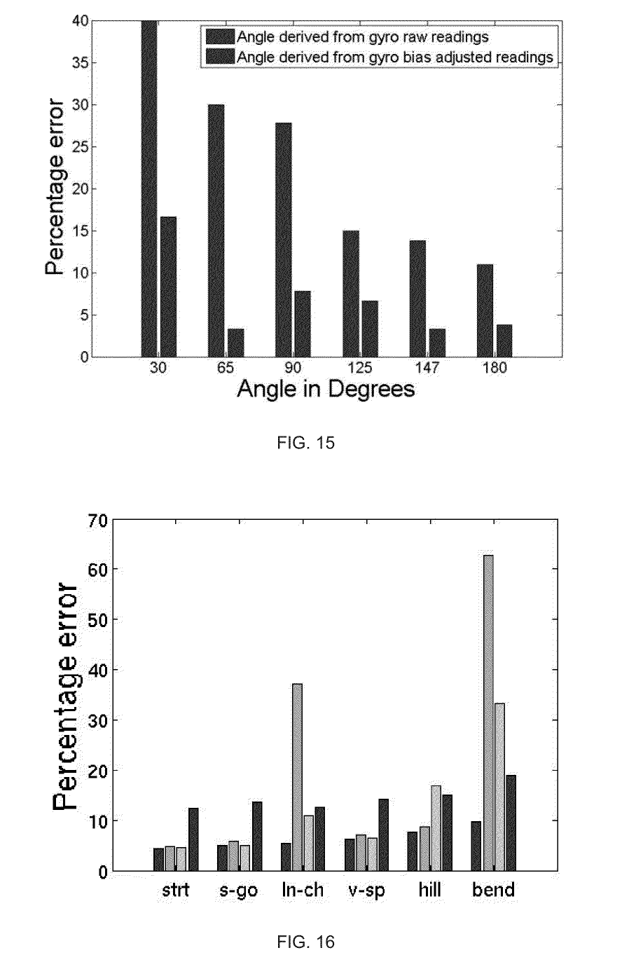

The results appear in FIG. 15. The average error in angle estimation over 6 different cases with 20 samples each reduced from 23.02% to 6.92% after correcting the bias.

### Evaluation of Distance Estimation

A tag node 102 was affixed inside a wooden box, placed in a car, and driven through over 300 different road segments. The wooden box was allowed to move freely at the base of the back seat of the car whenever it encountered jerks or radial acceleration. The measurements from the accelerometers and gyroscopes from the tag 102 node and ground truth using the GPS on an ANDROID™ G1 phone that was sampled every second were collected. The evaluation of distance estimation focuses on two questions: (1) what is the impact of various stages in distance estimation and (2) what level of accuracy are we able to obtain using the entire process presented herein.

For the first question, the following six scenarios of travel were considered: smooth travel along a straight road, stop and go traffic, travel with frequent lane changes, travel with frequent change in speeds (i.e., rapid acceleration and deceleration), travel on hilly roads, and travel on roads with frequent (often sharp) bends. The measurements obtained were processed using the method described herein in the context of FIG. 12A. To evaluate the impact of some of the stages in this method, various stages were omitted. In particular, the impact of reorientation, correction for radial acceleration, and correction for the drift was evaluated.

The results appear in FIG. 16. On road segments where the tag node 102 may shift its orientation due to bends or frequent lane changes, maintaining correct orientation by reorienting the accelerometer axes (step S808) can improve the error in distance estimation by over 5 times. On roads that have significant radial acceleration component due to hills or bends, correction for radial acceleration (step S816) can improve the error in distance estimation by 2-3 times. Finally, correction for drift (step S818) improves the distance estimation error in all cases uniformly (by over 100%).

For the second question, the error in the estimate of distance traveled and that obtained using GPS on the ANDROID™ G1 phone was computed. All six types of travel as described herein were covered, but spread over 300 different road segments whose length varied between 0.2 to 1.5 miles. All stages of the distance estimation method described herein were applied in this case.

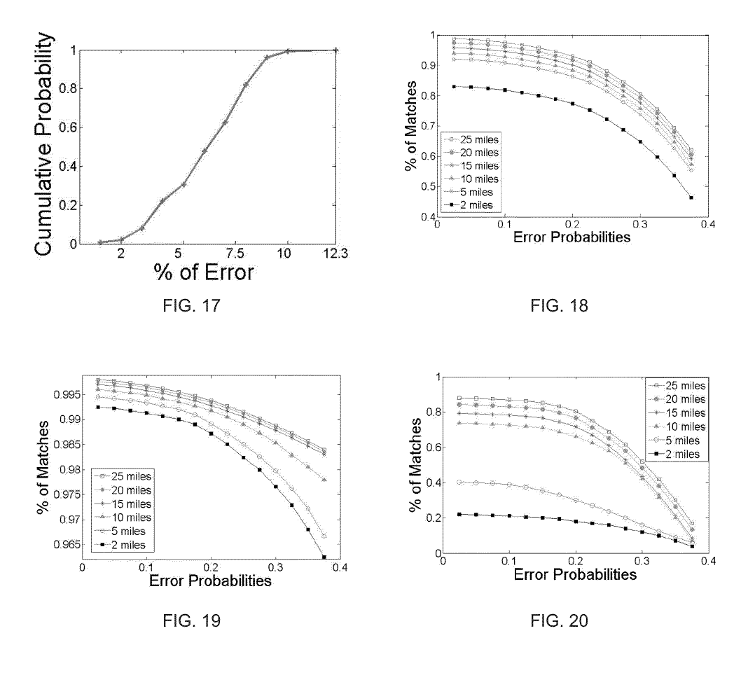

The results appear in FIG. 17. The errors in distance estimation are usually below 10%. In some rare case, the errors reach 12.3%, but no higher.

### Evaluation of Map Reconstruction

To evaluate the quality of path reconstruction, the following questions were considered: (1) what is the impact of errors in distance estimation in the quality of path reconstruction, (2) how does the quality of path reconstruction degrade if no stops are used (i.e., only total distance of each segment is used as an observable), (3) how does the quality of path reconstruction improve if crude localization from cell towers is available at each turn, (4) how does the quality of path reconstruction degrade if travel includes highways where long stretches of travel can occur without any stops, and (5) how often is the true path in top-k paths, in cases when the true path may not be the one found by Viterbi decoding. The last question is relevant for this application because, in case the stolen property is not found in the most probable destination, additional searches can be made at other probable destination to recover the asset 106.

A map representation of Memphis, Tenn. from the Open Street Map project, which provides a readily-available representation of the road networks of cities that can be easily processed into a data structure suitable for a Hidden Markov Model, was utilized. The Open Street Map data, which is retrievable from the Open Street Map website (www.openstreetmap.org) as an XML format OSM file (as well as through a web-based API), consists primarily of two types of XML tags: node element tags, each with a unique reference number, geographic coordinates, and meta data such as indications of traffic lights or stop signs; and way element tags, each with sequentially ordered references to node elements, as well as other meta data, such as street name and type (e.g., highway, residential, etc.). The node elements act as “shape points” with fixed locations, while the way elements represent roads and paths by “tracing along” the series of referenced nodes in sequence.

To build a graph of the road network, the OSM file was first parsed for all of the node tags to create RoadNode objects holding the location coordinates and original reference numbers, as well as booleans to indicate if the node is a traffic light, stop sign, or any other kind of potential stop. The file was then parsed for all of the road-type way elements (ignoring bike trails, foot paths, and the like) and processed into a series of several RoadSection objects, which represent the small section of road between two node points.

Each sequential pair of nodes (in each way's ordered series of nodes) becomes the two end points of the RoadSection, and their latitude and longitude coordinates are used to determine the distance of the RoadSection via the Haversine formula, which provides great-circle distances between two points on a sphere from their longitudes and latitudes. The actual street name is stored in each RoadSection object so that it is easily identifiable. The bearing (i.e., angle from true North) of each road section is also computed using its two coordinates, which is used to determine the angle between adjacent RoadSections. After all of the RoadSection objects are created from the data set, an algorithm populates each RoadSection objects with a list of references to other RoadSection objects that are adjacent to itself and the angles between them and itself. The outcome of this is the graph-like data structure with most of the details needed by the HMM model described herein.

The observables for the HMM consists of a sequence of distance and turns. The distances consists of either stopping estimates between different intersections where the vehicle experiences a red light or STOP sign or distance traveled between two successive turns into different road segments. Hence, in order to create the observables, a synthetic path is generated using the processed data from the Open Street Map GIS database. The synthetic path begins at some node in the map structure and traverses through a path of RoadSections, recording the length of each RoadSection and the angles between successive sections. If the node joining two successive RoadSections is a potential stop, meaning it represents a traffic light, it is chosen to be marked as a stop depending on a Markov chain. The Markov chain represents transitions of traffic lights from red to green and vice versa.

The estimates for the transition probabilities for the Markov chain were based upon driving through 300 stop lights. As per this estimate, the probability of getting a red light, if the previous traffic light was green is 0.43, and the probability of getting a red light if the previous light was red is 0.55. The first light was assumed to be red and the next traffic light was chosen to be a stop or pass depending on the resulting state of the Markov chain. Stop signals encountered along the synthetic path were always treated as STOPS.

For the turns, GPS coordinates were used to compute the angle between two road sections. If the angle between two successive RoadSections is less than some threshold and the node joining them is not marked as a stop, their distances are summed and the next RoadSection is then considered in the same fashion. The result is a series of ground truth distances, with stops and turns in between—the output expected from the tag node 102. After the paths are created, random, bounded adjustments were made to the distance values of each road segment between successive stops and/or turns to simulate errors in distance estimations. Since there could be delay of few seconds in activating the tracking module after detection of theft, an initial uncertainty in the original location of the stolen object was generated. A 500 meter radius was generated across the original location of the stolen object and all intersections within the radius were considered as a possible starting segment.

Additionally in all simulations it was assumed that a rough estimate of the final destination of the stolen object was available to by virtue of cell tower localization. The radius of uncertainty for such localization is typically lesser than 100 meters in an urban setting. To observe the trend of degradation in the quality of path reconstruction as a function of total length of the path, a range of values for total distance stretches (2, 5, 10, 15, 20, 25 miles) was considered. For each value of the total path length, a starting location was randomly selected 100 times, and for each instance, 10 different directions were considered for the final destination.

The results for urban streets are presented in FIG. 18. For path lengths of 5 miles or more, the true path was using identified through Viterbi decoding more than 90% of the time. The degradation in the quality of path reconstruction degrades slowly until about 20% error. Given that the errors in distance estimation obtained from our tag node 102 is 10% or lower in most cases, the quality of path reconstruction is promising for this application.

FIG. 19 presents the same results if crude localization is available at each turn. With this additional information, the probability of finding the correct path is more than 99% even with 10% error in distance estimation.

FIG. 20 presents the same result if cell tower localization at each turn is unavailable and the distance between stops are not used as observables. In this case the quality of path reconstruction degrades quite a bit, but is still over 75% for total path length of 10 miles or higher. This case provides a lower bound on the performance of systems described herein in the sense that if distance between successive stops are collapsed together (e.g., to tolerate stops in the middle of the road, not at the traffic lights), the quality of path reconstruction may degrade but will not be worse than the case where distance between stops are never used.

FIG. 21 presents the same results as above if highway travel is allowed in the path.

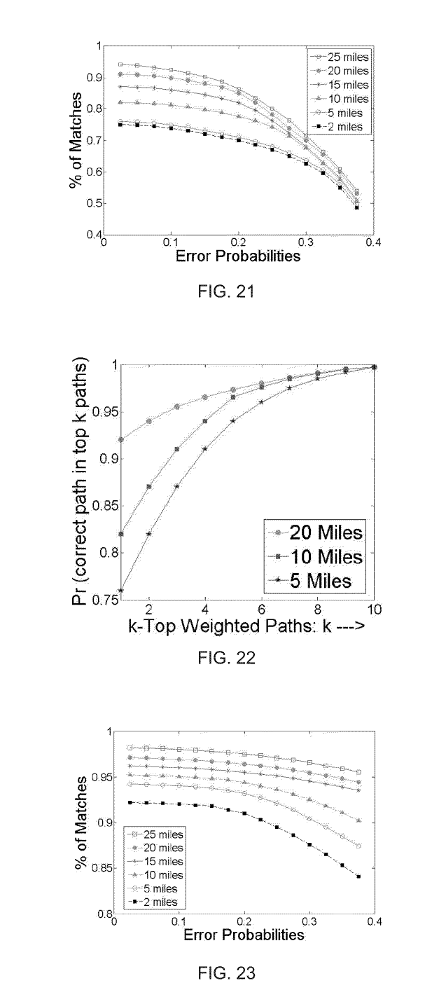

Referring to FIG. 22, if the top-k paths are considered rather than the most probable path, then the probability of finding the correct path (and the final destination) improves to over 90% if only top 4 paths are considered, even for total path length of 5 miles.

Finally, FIG. 23 depicts results when cell-tower based localization is available at each turn for the highway case. As depicted in FIG. 23, the quality of path reconstruction is over 90% for all path lengths, even with 20% error in distance estimation.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware, or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A theft detection node comprising:
a power source;
an accelerometer;
a gyroscope;
a transmitter; and
a microcontroller in communication with the power source, the motion detector, and the transmitter;
wherein the microcontroller is programmed to:
determine whether the theft detection node is being transported; and
if the theft detection node is being transported:
estimate the distance traveled between successive stops; and
transmit the estimated distance to a server.

2. The theft detection node of claim 1, wherein the microcontroller is further programmed to:
process signals generated by the accelerometer to remove jitters and noise.

3. The theft detection node of claim 2, wherein the microcontroller is further programmed to:
perform a 2^{nd} order Runge Kutta integration on the signals.

4. The theft detection node of claim 2, wherein the microcontroller is further programmed to:
apply a 2^{nd} order Butterworth filter to the signals.

5. The theft detection node of claim 1, wherein the microcontroller is further programmed to:
compute the median of m samples in a plurality of windows of the signals; and
compute the mean of n of a plurality of windows of the medians; wherein m and n are positive integers.

6. The theft detection node of claim 1, wherein the microcontroller is further programmed to:
maintain a running mean velocity over a period of time;
sum acceleration values between the successive stops; and
calculate an elapsed time between the successive stops.

7. A theft detection server comprising:
a communication module for communicating with at least one theft detection node;
a storage module for storing representations of one or more maps; and
a processing module for determining a path traveled by the theft detection node.

8. The theft detection server of claim 7, wherein the processing module determines the path through use of Viterbi decoding over a Hidden Markov Model having a plurality of states.

9. The theft detection server of claim 8, wherein the Hidden Markov Model has a starting state including all intersections within a radius r from a location where the theft detection node was initially deployed.

10. The theft detection server of claim 9, wherein each of the intersections is assigned a uniform probability.

11. The theft detection server of claim 8, wherein a transition in the Hidden Markov Model is created when the theft detection node detects a turn.

12. A method of estimating an angle of a turn utilizing a gyroscope, the method comprising:
receiving signals indicative of orientation from the gyroscope; and
performing a single integration of the signals.

13. The method of claim 12, further comprising:
receiving signals indicative of a stop from an accelerometer; and
estimating drift of the gyroscope during the stop.

14. A method of estimating a distance traveled between two successive stops utilizing an accelerometer, the method comprising:
receiving signals indicative of acceleration from the accelerometer;
processing the signals to remove noise and jitters;
computing the median of m samples in a plurality of windows of the signals, wherein m is a positive integer;
computing the mean of n of a plurality of windows of the medians, wherein n is a positive integer;
removing any radial components of acceleration from the means;
subtracting a mean of the means between the two successive stops from the means; and
computing a double integral of the means;
thereby estimating a distance traveled between two successive stops.

15. The method of claim 13, further comprising:
detecting that the accelerometer is stationary;
utilizing signals from the accelerometer to determine the orientation of the accelerometer relative to gravity; and
resolving future accelerometer signals to a fixed reference frame.

16. A method of estimating a distance traveled between two successive stops utilizing an accelerometer, the method comprising:
receiving signals indicative of acceleration from the accelerometer;
processing the signals to remove noise and jitters;
maintaining a running mean velocity over a period of time;
summing acceleration values between the successive stops; and
calculating an elapsed time between the successive stops;
thereby estimating a distance traveled between two successive stops.

17. The method of claim 16, wherein the distance traveled between the successive stops is estimated using d=( v̅−b*t)*t, where v̅ is the running mean velocity, b is the sum of all acceleration values between the successive stops, and t is the time elapsed between the successive stops.

18. A method of determining a path traveled by a node, the method comprising:
generating a Hidden Markov Model having a plurality of hidden states, each hidden state corresponding to a road segment;
receiving information about a turn t from a road segment j to a road segment k from the node;
if the turn t is the first turn, setting a start state;
if the turn t is not the first turn, computing the angle γ of the turn t;
receiving a distance d traveled by the node between the turn t and an immediately previous turn t-1 from road segment i to the road segment j;
associating margins of error ε_{d} and ε_{y} with distance d and angle γ, respectively;
pruning one or more hidden states based on the distance d and angle γ to produce a candidate set C;
assigning a prior probability
$${P}_{i} ( j ) = \frac{1}{\vert C \vert}$$
to each hidden state in the candidate set C;
estimating evidence for Bayesian inferencing Pᵢ(d|j);
computing a marginal probability P(d)=ΣP(j)P(d|j); and
computing a transition probability
$$P ( j \vert d ) = \frac{P ( d \vert j ) P ( j )}{P ( d )} .$$

19. The method of claim 18, wherein the start state includes all intersections within a radius r from a location where the node was initially deployed.

20. A method of determining a path traveled by a node, the method comprising:
generating a Hidden Markov Model having a plurality of hidden states, each hidden state corresponding to a road segment;
receiving information from the node about one or more turns and the distance traveled between successive stops; and
determining the most likely path for the distance between successive stops and a distance between successive turns.
